(19) United States
(12) Patent Application Publication
(10) Pub. No.: US 2024/0042555 A1
(43) Pub. Date: Feb. 8, 2024

(54) METHOD FOR CONTROLLING A DISTRIBUTION OF ENERGY INTRODUCED INTO A SUBSTRATE BY A LINE FOCUS OF A LASER BEAM, AND SUBSTRATE

(71) Applicant: SCHOTT AG, Mainz (DE)

(72) Inventors: Andreas Ortner, Gau-Algesheim (DE); David Sohr, Mainz (DE); Andreas Koglbauer, Trebur (DE); Jens Ulrich Thomas, Mainz (DE); Fabian Wagner, Mainz (DE); Oliver Sohr, Mainz (DE)

(73) Assignee: SCHOTT AG, Mainz (DE)

(21) Appl. No.: 18/492,036

(22) Filed: Oct. 23, 2023

Related U.S. Application Data
(63) Continuation of application No. PCT/EP2022/060534, filed on Apr. 21, 2022.

(30) Foreign Application Priority Data
Apr. 23, 2021 (EP) 21170243.6
Sep. 3, 2021 (EP) 21194904.5

(51) Int. Cl. B23K 26/53; B23K 26/073; B23K 26/0622; B23K 26/064; B23K 26/362; C03C 23/00

(52) U.S. Cl. CPC B23K 26/53; B23K 26/0738; B23K 26/0622; B23K 26/064; B23K 26/362; C03C 23/0025; B23K 2103/54

(57) ABSTRACT

A method for controlling an energy distribution introduced by at least one line focus of at least one laser beam in a substrate is performed by forming the line focus at least regionally in the substrate and influencing the laser beam with at least one phase mask to control the energy distribution in the substrate.

### CROSS-REFERENCE TO RELATED APPLICATIONS

The present application is continuation of international patent application PCT/EP2022/060534, filed on Apr. 21, 2022, which claims priority to European patent application 21170243.6, filed on Apr. 23, 2021, and European patent application 21194904.5, filed on Sep. 3, 2021, the entire contents of each of which is incorporated by reference herein.

### BACKGROUND OF THE DISCLOSURE

### 1. Field of the Disclosure

The present disclosure relates to a method for controlling an energy distribution introduced by at least one line focus of at least one laser beam within a substrate, and to a substrate.

### 2. Description of Related Art

In order to separate a substrate along a separating surface, laser-based methods are known, inter alia, from the prior art. Curved side surfaces can form at the separated substrate parts by a procedure in which, along the planned separating surface, modifications are introduced into the substrate or material is removed therefrom by the curved line focus of a laser. The separation subsequently takes place along the damage introduced.

However, these separating surfaces have the disadvantage that they are not formed symmetrically.

### SUMMARY OF THE DISCLOSURE

It is an object of the present disclosure to provide a reliable method to form a curved separating surface of a substrate with high symmetry. Moreover, it is an object of the present disclosure to provide a substrate having a symmetrical side surface.

These and other objects are achieved by the disclosure in accordance with a first aspect by which a method for controlling an energy distribution introduced by at least one line focus of at least one laser beam within a substrate is provided. The method includes forming the line focus at least regionally within the substrate and controlling the energy distribution within the substrate at least partly by influencing the laser beam by at least one phase mask.

The disclosure is based on the surprising finding that the deposition of the laser pulse energy around the vertex point of a curved line focus makes it possible to reliably attain a curved modification of the substrate material along the thickness region of the substrate. In particular, the method according to the disclosure makes it possible to attain a modification in the substrate material that is formed symmetrically around the vertex point.

In this respect, it has been recognized primarily that the distribution of the laser energy deposited in the substrate material, hence the energy distribution within the material, can be controlled particularly reliably and nevertheless simply with the aid of a phase mask. More precisely, by virtue of the laser beam being suitably influenced by the phase mask, it has surprisingly been found that the effect of shifting the intensity distribution of the line of focus, either in a vacuum or in the air, along the trajectory of the laser focus is suitable for controlling the distribution of the energy deposited in the material and thus for improving the modification of the material. In this regard, it is possible to determine the location, in particular the centroid, of the material damage along the focus trajectory and to place the material damage at a desired location along the line focus.

It is conventional practice to deposit the laser pulse energy along the focus trajectory in a manner shifted with respect to the vertex point thereof. In order nevertheless to attain a sufficient modification along the entire thickness region of a substrate, therefore, hitherto it has been necessary to shift the focus of the laser beam (for example an Airy beam) and thus also the vertex point of the, in particular curved, line focus in the direction of one of the two outer surfaces of the substrate to be separated in order to advantageously arrange the energy deposition in the center of the thickness region of the substrate.

In other words: since hitherto more energy was thus deposited above the vertex point, i.e. for instance in the direction of the upper outer surface of the substrate, in particular the outer surface facing the laser source, the vertex point of the line focus had to be placed nearer to the lower outer surface in order to advantageously place the energy deposition centrally within the thickness region of the substrate. Otherwise, the lower region was modified inadequately or at least modified to a lesser extent.

Accordingly, the separated substrate parts conventionally have a side surface that does not have a symmetrical course, but rather the vertex point is shifted toward one of the two outer surfaces.

In one embodiment, for example, a modification of the substrate material can take place by influencing the substrate material directly or indirectly by, at least partly, the energy introduced in the substrate material, and in particular by the line focus. In this case, strictly speaking, the electromagnetic field of the laser will cause a portion of the laser pulse energy to be introduced into the substrate material and to be deposited there in a distribution that is dependent on beam geometry and laser and substrate material parameters.

The disclosure therefore generally makes it possible to control the energy distribution produced by the line focus in the material by way of the energy distribution being spatially shifted as a result of the influencing of the laser beam by a phase mask.

In one embodiment, controlling the energy distribution comprises controlling the spatial extent and/or the centroid of the energy distribution.

The method is thus suitable particularly advantageous in connection with the structuring of surfaces. This is because the method makes it possible to place the energy distribution along the line focus at a desired position within the substrate.

In this regard, by the curved modification (including a curved region from which material was removed or displaced) which was produced in the substrate material by a curved line focus, it is also possible to influence or determine the curvature of the planned separating surface and hence the curvature of the side surface of the substrate parts after separation. A symmetrical curvature course of the side surface of the substrate parts can thus be attained by suitable influencing of the laser beam during the modification of the material.

The method therefore preferably further comprises introducing at least one modification in the material of a substrate region along the line focus that is formed and controlled in regard to the energy distribution, and/or separating the substrate along a separating surface predefined by a multiplicity of such modifications. A modification can comprise the example a change in the density, the refractive index, the stress values, the mechanical integrity and/or the etching rate, in particular acidic or alkaline etching rate, of the substrate material. A modification can for example also comprise removing substrate material from the substrate, displacing substrate material, in particular compressing substrate material into the surrounded substrate, and/or producing microcracks.

By virtue of the orientation of the curvature of the line focus being chosen in such a way that the course of the curvature, in particular the acceleration direction of the curvature, runs non-parallel to and/or perpendicular to the main extension direction of the planned separating surface, the curvature of the separating surface and thus that of the side surfaces of the substrate parts can be influenced or determined by the curvature of the line focus.

Therefore, in one embodiment, it is preferred for the curvature not to run parallel to the planned separating line, but rather perpendicular thereto, for example.

In one embodiment, preferably, the curvature of the side surface of a divided substrate part, in particular the curvature along a direction perpendicular to the main extension direction of the side surface, is concomitantly determined by the alignment of the line focus, in particular the orientation of the curvature, within the substrate.

The disclosure thus makes it possible for the first time to attain a symmetrical course of a curved separating service directly after the separating process with mediation of the modified substrate regions, in particular without rework steps such as polishing for the purpose of edge shaping, specifically primarily even with very thick substrates, i.e. for instance substrates having a thickness of more than 500 μm. This can be achieved by positioning the energy distribution around the vertex point of the focused trajectory.

This is because the observed deposition of the laser pulse energy at a position shifted from the vertex point along the focus trajectory can be compensated for by the influencing by the phase mask. This has the effect that a symmetrical manifestation of the material modification is attained. Moreover, a uniform material modification running completely through the material can thus also be attained particularly reliably.

The energy distribution can thus be introduced into the substrate material by the line focus. In other words, an energy can be deposited in a spatially distributed manner in the substrate by the line focus and this distributed energy will be controlled according to the disclosure.

It is thus possible to attain a symmetrical manifestation of the separating surface produced. This applies to thin substrate thicknesses, for example starting from a thickness of 10 μm and/or up to a thickness of 500 μm. Moreover, it equally also applies even to substrate thicknesses of 500 μm or greater, for example for a substrate thickness of 525 μm. By way of example, the substrate can have a thickness of 700 μm or more, of 1 mm or more, of 3 mm or more, of 5 mm or more, or even of 7 mm or more.

Consequently, the solution according to the disclosure makes it possible, inter alia, to flexibly adjust the position of the energy distribution, in particular relative to the vertex point of the focus trajectory, and thus the position and shape of the modification produced in the substrate material.

In one embodiment, the thickness of the substrate material is measured between the two main sides of the substrate.

Preferably, the substrate is transparent, in particular to the wavelength of the laser beam, preferably in the visible wavelength range, in the IR wavelength range and/or in the UV wavelength range.

Preferably, the substrate is composed of a glass material or comprises the latter. Alternatively, or supplementarily, the substrate can also comprise or consist of glass ceramic, silicon, sapphire and/or quartz glass.

The line focus is preferably a curved line focus. The line focus is Alternatively, or supplementarily a focus of an Airy beam. Preferably, the line focus is Alternatively, or supplementarily a focus of a laser beam of a pulsed laser, in particular of an ultrashort pulsed laser having pulse widths of 10 ps or less, preferably of 5 ps or less, preferably of 3 ps or less, preferably of 1 ps or less, preferably of 0.5 ps or less.

The phase mask phase-modulates the laser beam.

In this case, the phase mask preferably influences the laser beam by virtue of its imposing an additional optical, non-constant phase on the laser beam by way of a laterally resolved change in the optical path length.

The phase mask can be realized for example as a freeform optical unit, as a diffractive optical element (DOE), as a Cousteau-optic modulator (AOM), or as a liquid crystal on silicon spatial light modulator (LCOS-SLM).

However, the phase mask can also be realized wholly or partly by other elements which enable a defined phase change.

In one embodiment, a DOE is used as phase mask.

The method is thus particularly well suited in the field of separation and surface structuring of substrates, in particular, substrates. By way of example, the method is particularly well-suited to preparing and/or carrying out the separating of such substrates into substrate parts.

Advantageously, influencing the laser beam can comprise or constitute static influencing. In this case, “static influencing” is understood to mean for example a manifestation that is time-independent during and/or owing to the controlling of the energy distribution within the substrate, in particular during and/or owing to the influencing of the laser beam, for example in regard to the spatial orientation, the position and/or the spatial extent, of the line focus in the substrate. In other words, the manifestation of the line focus does not change during the controlling and/or influencing and/or during the modifying of the substrate.

By way of example, for static influencing of the laser beam, it is possible to fixedly adjust the influencing of the laser beam by, at least, at least one phase mask, in particular the offset of the laser beam on the phase mask, preferably according to a constant pulse energy and/or pulse duration of the laser.

Advantageously, influencing the laser beam can comprise or constitute dynamic influencing. In this case, “dynamic influencing” is understood to mean for example a manifestation that is time-dependent during and/or owing to the controlling of the energy distribution within the substrate, in particular during and/or owing to the influencing of the laser beam, for example in regard to the spatial orientation, the position and/or the spatial extent, of the line focus in the substrate. In other words, the manifestation of the line focus changes time-dependently at least at times during the controlling and/or influencing and/or during the modifying of the substrate.

By way of example, for dynamic influencing of the laser beam, it is possible to carry out time-dependently the influencing of the laser beam by , at least, at least one phase mask, in particular the offset of the laser beam on the phase mask, preferably for a constant pulse energy and/or pulse duration of the laser.

Alternatively, or supplementarily, it can also be provided that the at least one phase mask is a phase mask with a cubic phase distribution or a higher-order, in particular odd-order, distribution and/or the phase mask is arranged in the beam path of the laser beam upstream of the substrate, and in particular the laser beam, preferably the centroid of the beam cross-section existing in the plane of the phase mask, has an incidence point on the phase mask.

A cubic phase mask is simple to set up and reliably affords the possibility of controlling the energy distribution.

An odd-order phase mask (for orders greater than or equal to 3) is advantageous since, in this case, a lateral shift of the input beam on the optical unit in a constant direction can be attained a shift of the centroid of the energy distribution of the focus (hence the energy distribution in the substrate) in a constant direction along the trajectory and/or propagation direction of the laser beam.

Alternatively, or supplementarily, it can also be provided that forming the line focus comprises adjusting the position of the vertex point of the, in particular curved, line focus a long a depth region, preferably a thickness region, of the substrate, and wherein preferably the position of the vertex point of the line focus (i) is adjusted centrally along the depth region of the substrate, and/or (ii) at an, in particular vertical, distance from the central position along the depth region of the substrate, and in particular the, in particular vertical, distance along the depth region is (a) more than 0.1%, preferably more than 1%, preferably more than 5%, preferably more than 10%, preferably more than 20%, preferably more than 30%, preferably more than 40%, preferably more than 45%, of the thickness of the substrate, (b) less than 50%, preferably less than 45%, preferably less than 35%, preferably less than 25%, preferably less than 15%, preferably less than 10%, preferably less than 5%, preferably less than 3%, preferably less than 1%, of the thickness of the substrate and/or (c) between 0.1% and 49%, preferably between 0.1% and 10% or between 1% and 40%, preferably between 5% and 30%, preferably between 10% and 25%, of the thickness of the substrate.

By virtue of the vertex point of the curved line focus being positioned correspondingly centrally, the trajectory of the line focus extends symmetrically around the central plane of the substrate. This opens up the possibility of introducing into the substrate a modification which extends symmetrically around the central plane of the substrate.

It is thus possible to introduce into the substrate a modification which extends symmetrically around the central plane of the substrate by virtue of the fact that furthermore, for example, the energy distribution is also positioned centrally around the vertex point by way of suitable influencing by the phase mask.

However, vertex point positioning offset in relation to the center can also be preferred in order to attain corresponding courses in the substrate. In this case, it can be advantageous if the distance is measured as follows: A (hypothetical) central position of the vertex point along the depth region of the substrate is ascertained and the target position along the depth region of the substrate is ascertained and the difference between the two positions constitutes the distance. If the depth region runs perpendicularly to the outer surface of the substrate, the distance is also indeed the vertical distance. A possible offset of the vertex point in a direction running perpendicularly thereto, hence running horizontally, such as can occur for a curved line focus, is thus insignificant at least for the vertical distance.

In this case, a direction “along the depth region” preferably runs perpendicularly to at least one of the outer surfaces of the substrate, in particular perpendicularly to that outer surface of the substrate which faces the laser source.

Each of the described positionings of the line focus and thus the Vertex point thereof can be affected for example by varying the distance between the focusing optical unit used and the substrate. By way of example, for this purpose, the substrate and/or the focusing optical unit can be translated along the beam propagation direction. The laser beam is preferably focused onto the substrate with the focusing optical unit.

Alternatively, or supplementarily, the positioning of the line focus and thus the vertex point thereof can be affected by adapting the focal length of the system, wherein preferably the numerical aperture of the system is maintained. By way of example, for this purpose, the focusing optical unit comprises a multi-lens system having a variable focal length.

The central plane here is preferably that play which advantageously runs centrally within the substrate, i.e., between the two outer surfaces thereof, and whose normal vector runs parallel to the main extension direction of the laser beam.

In one embodiment, the position of the vertex point is adjusted in such a way that the vertex point is situated outside the substrate.

Alternatively, or supplementarily, it can also be provided that controlling the energy distribution within the substrate furthermore comprises adjusting the pulse energy, the pulse duration, the number of pulses in the burst, the energy distribution in the burst and/or the laser wavelength,
wherein preferably the pulse energy is adjusted in such a way that the line focus within the substrate has at least one portion along which the substrate material is modified on account of the energy deposited in the substrate, in particular as a result of an interaction between the energy and the substrate material, wherein preferably the portion has a length of (a) more than 0.1 mm, preferably more than 0.3 mm, preferably more than 0.5 mm, preferably more than 0.7 mm, preferably more than 1 mm, preferably more than 3 mm, preferably more than 5 mm, (b) less than 5 mm, preferably less than 3 mm, preferably less than 1 mm, preferably less than 0.7 mm, preferably less than 0.5 mm, preferably less than 0.3 mm, preferably less than 0.1 mm, and/or (c) between 0.1 mm and 5 mm, preferably between 0.5 mm and 2 mm.

It has been recognized that not only can the phase mask influence the energy distribution, in particular the position thereof along the focus trajectory, but also a change in the pulse energy can lead to a change in the energy distribution, in particular the position thereof along the focus trajectory and/or the shape thereof, such as the spatial extent. Therefore, the energy distribution can be concomitantly controlled by way of the pulse energy.

Equally, the further parameters such as the pulse duration or the number of pulses in the burst and the wavelength of the laser beam can also be used correspondingly for control, as established by the inventors.

Preferably, the pulse energy is measured upstream of the focusing optical unit. In this application, therefore, this should advantageously be taken into consideration for corresponding values of the pulse energy, unless the respective context reveals something different.

In this respect, it has also been recognized that, in particular for an adjusted position of the vertex point of the, in particular coat, line focus along a depth region, preferably a thickness region, of the substrate, a pulse energy is selectable in such a way that secondary maxima of the line focus are not manifested, or are manifested only to a small degree, in the substrate, namely for example that the intensity of the primary maximum in the transverse plane, said primary maximum manifesting the desired line focus along the propagation, at the linear focus, i.e. at the location of maximum intensity along the propagation, is at least one.1 times, preferably at least 1.3 times, preferably at least 2 times, preferably at least 3 times, preferably at least 5 times, preferably at least 7 times, preferably at least 10 times, preferably at least 20 times, preferably at least 30 times, preferably at least 50 times, preferably at least 100 times, the maximum intensity of an arbitrary secondary maximum in the same transverse plane or along the entire propagation.

Increasing the contrast between the primary maximum, which manifests the desired line focus, and all secondary maxima in the substrate is advantageous since the influence of said secondary maxima on a material modification can thus be reduced or eliminated. It is thus possible to prevent shielding effects as a result of secondary maxima and therefore to attain a particularly reliable formation of the line focus and thus to introduce a particularly reliable material modification into the substrate.

In order to be able to introduce a modification into the substrate by the line focus and the energy distribution introduced into the substrate by said line focus, and energy density that is higher than a, in particular material-dependent, threshold value is necessary at the corresponding locations. Therefore, it is advantageous if the distribution of the energy is adapted by way of a suitably chosen pulse energy so that enough energy is deposited in the substrate to attain an interaction between the energy and the material which leads to the modification. It can be particularly advantageous for the method according to the disclosure if a high energy density is attained in a spatially narrowly delimited volume. This makes it possible particularly advantageously to introduce modifications in the substrate which are accompanied by spatially narrowly delimited, but highly pronounced, damage of the material and thus enable an easy separation of the substrate along the desired separating surface, without the side surfaces of the separated substrate parts being weakened.

Adapting the pulse energy makes it possible for example to change the length of a portion of the line figures within which a specific threshold value of the energy density is exceeded everywhere, in order thus to produce in the material modifications (including the removal of material) that extend at least along the portion.

By way of example, the threshold value can be dependent on the material of the substrate.

Adapting the pulse energy also makes it possible for example to change the position adopted by the energy distribution, in particular the centroid thereof, along the focus trajectory.

Therefore, the pulse energy is a supplementary possibility for controlling, in particular adapting, the energy distribution, for example with regard to the position of its centroid and/or with regard to the length of the portion of the line focus along which a sufficiently high energy deposition takes place in the substrate material.

Alternatively, or supplementarily, it can also be provided that:
(i) the pulse energy is adjusted at least at times
   (a) to 50 μJ or more, preferably 100 μJ or more, preferably 200 μJ or more, preferably 300 μJ or more, preferably 400 μJ or more, preferably 500 μJ or more, preferably 600 μJ or more, preferably 1000 μJ or more, preferably 1500 μJ or more, preferably 2000 μJ or more, preferably 2500 μJ or more, preferably 3000 μJ or more, preferably 3500 μJ or more, preferably 4000 μJ or more, preferably 4500 μJ or more, preferably 5000 μJ or more,
   (b) to 5000 μJ or less, preferably 4500 μJ or less, preferably 4000 μJ or less, preferably 3500 μJ or less, preferably 3000 μJ or less, preferably 2500 μJ or less, preferably 2000 μJ or less, preferably 1500 μJ or less, preferably 1000 μJ or less, preferably 600 μJ or less, preferably 500 μJ or less, preferably 400 μJ or less, preferably 300 μJ or less, preferably 200 μJ or less, preferably 100 μJ or less, preferably 50 μJ or less,
   and/or
   (c) to between 50 μJ and 5000 μJ, preferably between 10 μJ and 100 μJ, between 100 μJ and 300 μJ, between 150 μJ and 300 μJ, between 200 μJ and 400 μJ, between 300 μJ and 600 μJ, between 600 μJ and 1000 μJ, between 800 μJ and 2000 μJ, between 1500 μJ and 3000 μJ, between 2000 μJ and 4500 μJ or between 3000 μJ and 5000 μJ.
and/or
(ii) the pulse energy is adjusted such that there is an average line energy density of
   (a) 1 μJ/mm or more, preferably 5 μJ/mm or more, preferably 10 μJ/mm or more, preferably 20 μJ/mm or more, preferably 30 μJ/mm or more, preferably 40 μJ/mm or more, preferably 50 μJ/mm or more, preferably 60 μJ/mm or more, preferably 70 μJ/mm or more, preferably 80 μJ/mm or more, preferably 90 μJ/mm or more, preferably 100 μJ/mm or more, preferably 150 μJ/mm or more, preferably 200 μJ/mm or more, preferably 250 μJ/mm or more, preferably 300 μJ/mm or more, preferably 350 μJ/mm or more, preferably 400 μJ/mm or more, preferably 500 μJ/mm or more, preferably 600 μJ/mm or more, preferably 700 μJ/mm or more, preferably 800 μJ/mm or more, preferably 900 μJ/mm or more,
   (b) 1000 μJ/mm or less, preferably 900 μJ/mm or less, preferably 800 μJ/mm or less, preferably 700 μJ/mm or less, preferably 600 μJ/mm or less, preferably 500 μJ/mm or less, preferably 400 μJ/mm or less, preferably 350 μJ/mm or less, preferably 300 μJ/mm or less, preferably 250 μJ/mm or less, 200 μJ/mm or less, preferably 180 μJ/mm or less, preferably 160 μJ/mm or less, preferably 140 μJ/mm or less, preferably 120 μJ/mm or less, preferably 100 μJ/mm or less, preferably 90 μJ/mm or less, preferably 80 μJ/mm or less, preferably 70 μJ/mm or less, preferably 60 μJ/mm or less, preferably 50 μJ/mm or less, preferably 40 μJ/mm or less, preferably 30 μJ/mm or less, preferably 25 μJ/mm or less, preferably 20 μJ/mm or less, preferably 15 μJ/mm or less, preferably 10 μJ/mm or less, preferably 5 μJ/mm or less,
   and/or
   (c) between 1 μJ and 200 μJ/mm, in particular between 10 μJ/mm and 120 μJ/mm, preferably between 10 μJ/mm and 50 μJ, between 40 μJ/mm and 80 μJ/mm, between 70 μJ/mm and 100 μJ/mm, or between 80 μJ/mm and 120 μJ/mm.

The proposed pulse energies and average line energy densities are particularly preferred for a glass substrate.

If a burst pulse is used, then the pulse energy and the burst energy can preferably be converted into one another in accordance with the relationship BURST ENERGY=PULSE ENERGY×NUMBER OF PULSES IN THE BURST. A pulse energy of, for example, 50 μJ and N=2 pulses in the burst thus lead to a burst energy of 50×2 μJ=100 μJ and vice versa. In this regard, the pulse energy can thus also be adjusted correspondingly by adjusting a burst energy.

Preferably, the average line energy density is defined as the quotient of laser pulse energy and substrate thickness. The average line energy density can alternatively preferably also be defined as the quotient of laser pulse energy and length of the modification in the substrate.

The inventors assume that preferably a local line energy density, i.e. an energy density integrated over the plane perpendicular to the laser propagation direction, of 1 μJ/mm or more is required in order to produce modifications, for instance in the form of a change in the local refractive index of the material, in borosilicate glass using an Airy beam.

Alternatively, or supplementarily, it can also be provided that controlling the energy distribution within the substrate comprises (a) adapting the spatial extent of the energy distribution, (b) adapting, in particular shifting, the position of the maximum material damage, in particular caused by the nonlinear interaction between laser and substrate material, and/or (c) adapting, in particular shifting, the position of the energy distribution, in particular a, preferably global, maximum of the energy distribution and/or the centroid of the energy distribution, preferably along the trajectory of the laser beam, in particular that of the line focus,

wherein preferably
(i) after adapting the position of the energy distribution, at least one maximum of the energy distribution is positioned at the vertex point of the, in particular curved, line focus,
(ii) after adapting the spatial extent and/or the position of the energy distribution, a modification of the substrate material that proceeds along the entire substrate thickness is carried out or takes place,
and/or
(iii) adapting the position of the energy distribution at least partly comprises coordinating the influencing of the laser beam by the phase mask and the adjusting of the pulse energy with one another.

By shifting the maximum of the energy distribution, it is possible to determine the location of the (maximum) modification particularly reliably. It is thus possible for example for a planned separating process on the substrate to be reliably prepared and/or subsequently carried out.

By positioning the maximum of the energy distribution within the substrate material at the vertex point, a modification that is symmetrical around the vertex point can be introduced into the substrate. By optionally positioning the vertex point, for its part, symmetrically within the thickness region of the substrate, it is thus possible to obtain a separating surface and accompanying that a side surface of the separated substrate parts which has a symmetrical course (in particular within a cross-sectional plane spanned by the normal vector of an outer surface of the substrate and a normal vector of the planned separating surface).

In embodiments, it is particularly preferred for the influencing of the laser beam by the phase mask and the adjusting of the pulse energy to be coordinated with one another. In this regard, the spatial extent and/or position of a modification within the substrate can be controlled very flexibly.

By way of example, the pulse energy can be chosen in such a way that along the line focus within the entire thickness region of the substrate everywhere there is an energy deposition resulting from the line focus in the material which has a magnitude high enough that modifications can be produced in the material along the entire thickness region. This can be necessary for example in order to attain a modification in the substrate along the entire thickness region. At the same time, by influencing coordinated therewith using the phase mask, the position of the energy distribution is adapted, for instance in such a way that it is maximum is situated on the vertex point of the focus trajectory. It is thus possible to attain overall a symmetrical (for example with respect to the plane, in particular the central plane, of the substrate in which the vertex point of the focus trajectory also lies) modification of the substrate material along the entire thickness region.

In one embodiment, the location of the maximum modification of the substrate is at the location of the vertex point of the line focus trajectory and/or in the center along the thickness region of the glass substrate.

Alternatively, or supplementarily, it can also be provided that influencing the laser beam by at least the at least one phase mask comprises the laser beam being incident in a manner offset with respect to the central point of the phase mask, wherein the central point is that location of the phase mask at which a laser beam incident on the phase mask with a diameter tending toward zero is influenced by the saddle point of the phase distribution imposed on the phase mask, and wherein preferably the offset takes place within the mirror plane of the phase distribution,

wherein preferably the offset is between 0.1 μm and 5000 μm, preferably between 1 μm and 3000 μm, preferably between 1 μm and 2000 μm.

A particularly simple and reliable possibility for influencing the laser beam is to cause the latter to be incident on the phase mask at different positions. This is because the phase mask influences the laser beam, in particular with regard to the energy distribution at the focus, depending on the position at which the laser beam is incident on the phase mask. Preferably, the incidence point can be understood here as the centroid of the beam cross-section existing in the plane of the phase mask.

In this regard, it has been established, in particular, that primarily for a cubic phase mask, with an increasing offset of the incidence point of the laser beam (put better: that of the centroid of its cross-section in the plane of the phase mask) from the central point of the phase mask (particularly if the offset takes place within the mirror plane of the phase distribution), within the substrate the location of maximum energy on the focus trajectory moves away from the vertex point, specifically in one direction or the other along the trajectory depending on the sign of the offset.

When this application refers to the central point of the phase mask, this is preferably understood to mean that location of the phase mask at which a laser beam incident on the phase mask with a diameter tending toward zero is influenced by the saddle point of the phase distribution imposed on the phase mask.

The phase distribution and thus also the location of the saddle point of the phase distribution on the phase mask can be determined by a microscope, for example. Alternatively, the location of the saddle point can also be determined experimentally, for example by a procedure in which a laser beam (or the centroid thereof in the beam cross-sectional plane on the phase mask) is incident on the phase mask at different locations and the central point is identified as that location of the phase mask at which the laser beam that has passed through the phase mask is influenced in such a way that with suitable imaging in the linear propagation (measurable by a microscope set-up or ablation patterns on a substrate surface) the maximum intensity is reached at the vertex point of the parabola, and/or the intensity distribution is distributed symmetrically around said vertex point, and the secondary maxima are manifested symmetrically upstream and downstream of the focus. To put it another way, the linear propagation corresponds to an ideal Airy beam.

It is preferable for the saddle point and thus also the central point to be situated at the geometric center point of the phase mask. This can be achieved for example by a centered phase function.

Preferably, the change in depth of the maximum of the energy distribution for an offset dx results as a change in the effective focal length downstream of the focusing optical unit used by an absolute value df the according to the equation indicated:

$$df = \frac{1}{\frac{1}{{f}_{0}} + \frac{\sqrt{2} {β}^{3} dx}{{k}_{0}}} - {f}_{0}$$

In this case:
k₀ is the wave vector where k₀=2*pi*n/lambda, with wavelength lambda and refractive index n of the medium within which the focus is formed
f₀ is the focal length of the focusing optical unit used
beta is the scaling factor of the cubic phase phi, where

$$φ = exp ( \frac{i β}{3} * ( {x}^{3} + {y}^{3} ) ) ,$$

for example where β=3^{1/3} mm⁻¹, for x and y in mm.

Consequently, the proposed method thus makes it possible to produce a focus shift by way of a lateral beam offset, and to concomitantly utilize this focus shift for controlling the energy distribution.

It is thus advantageously possible to observe how the offset of a laser beam on a (in particular cubic) phase mask influences the position of the maximum of the focus intensity and thus effectively also that of the energy distribution in the substrate along the focus trajectory.

In this regard, preferably, with an increasing offset of the input beam on the phase mask from the center of the phase mask and/or within a plane of symmetry of the phase mask, the location of the maximum of the energy distribution is shifted vis-à-vis (i) the vertex point of the trajectory of the line focus and/or (ii) the point on the trajectory of the line focus whose tangent is parallel to the optical axis and which corresponds to the vertex point of the line focus produced by a centered input beam.

Therefore, preferably, the line focus is a focus of an Airy beam and/or as a result of the influencing of the laser beam by, at least, at least one phase mask, the location of the maximum of the energy distribution is shifted vis-à-vis the vertex point of the Airy trajectory, produced in particular by a centered input beam, specifically preferably along the Airy trajectory.

Therefore, preferably, the line focus is a focus of an Airy beam and/or as a result of the influencing of the laser beam by, at least, at least one phase mask, the location of the maximum of the energy distribution is shifted vis-à-vis the vertex point of the focus, specifically preferably along the line focus.

Alternatively, or supplementarily, it can also be provided that:
(i) the offset is adjusted
   (a) by moving the phase mask relative to the laser beam;
   (b) by at least one rotated plane-parallel plate, in particular composed of a glass material and/or an optical material, that is preferably transparent at the laser wavelength;
   (c) by at least two prisms arranged one behind another in the beam path, wherein the prisms preferably have identical prism angles and preferably the second prism is arranged in a manner rotated about the optical axis by 180° relative to the first prism;
   and/or
   (d) by translating, in particular within the beam path and/or parallel to the direction of the incident beam, a deflection mirror that deflects the laser beam;
and/or
(ii) the offset is adjusted by deflection of the laser beam, passing preferably parallel to and/or along the center axis of the phase mask, by at least one first means, such that the direction vector of the beam incident on the phase mask forms an angle with the direction vector of the center axis of the phase mask, wherein preferably the angle is 1/500 radian or less, preferably 1/1000 radian or less, preferably 1/2000 radian or less,
   and wherein preferably the deflection is adjusted by the first means comprising:
   (a) at least one rotatably mounted prism;
   (b) at least one rotatably mounted mirror;
   (c) at least one polygon or galvo scanner;
   (d) at least one acousto-optic modulator;
   (e) at least one liquid crystal on silicon spatial light modulator;
   and/or
   (f) at least one microelectronic mirror component;
   and wherein preferably furthermore a second means identical to the first means is provided and is arranged in the beam path upstream or downstream of the phase mask and/or is controlled synchronously with the first means in order to deflect the laser beam in such a way that the latter is incident perpendicularly on the phase mask and/or the substrate and/or passes parallel but offset with respect to the course before being deflected by the first means.

Accordingly, primarily two principles for adjusting the offset are particularly preferred. In one principle, the laser beam is incident parallel to the center axis of the phase mask (alternatively also: parallel to the optical axis of the system used for focusing, including the phase mask and the focusing optical unit, such as a microscope objective or an aspherical lens). In the other principle, the laser beam is incident at an angle with respect to the center axis of the phase mask.

In the latter, the oblique (relative to the center axis of the phase mask) beam path can thereby be reversed again, as it were, by the angle being corrected by an identical means. Consequently, the beam is offset by the first and second means as a result, but passes along parallel directions upstream of the first means and downstream of the second means.

If the lateral offset of the input being on the, in particular cubic, phase mask is produced by a rotated plane-parallel plate, the attainable maximum offset can be adapted very easily by way of the thickness, refractive index and lateral extent of the plane-parallel plate relative to the diameter of the laser beam.

If the offset is realized by two prisms situated one behind another in the beam path and having identical prism angles, the attainable offset can be adapted very easily by way of the size of the prisms relative to the diameter of the laser beam, the deflection angle of the prisms and the maximum distance between the latter. By way of example, the sizes, angles and distances can be chosen as follows: size, in particular Deventer, of the prism of between 10 mm and 60 mm (or even more than 60 mm), preferably of between 10 mm and 26 mm; deflection angle according to the equation x=sin(th)*d, with the lateral beam offset x, the deflection angle th and the distance between the presence d; distance of between 1 mm and 200 mm (or even more than 200 mm).

If the offset is attained by translating a deflection mirror in the beam path, a translation parallel to the direction of the incident beam is particular advantageous. This is because as a result the maximum offset is not limited by the size of the optical unit.

These options preferably produce a pure lateral offset without changes in the beam direction.

Particularly in the case of sufficiently small deflections and a sufficiently large available distance (for example 100 cm or more, preferably 150 cm or more, preferably 200 cm or more, preferably 300 cm or more, preferably 400 cm or more) with respect to the phase mask, the desired effect of an offset can also be attained particularly reliably by way of a change in the angle of the input beam.

Adjusting the deflection using a scanner or and produced-optic modulator (AOM) is particularly preferred. This is because owing to the short response times of these components, the latter are also suitable, in principle, for attaining a significant deflection even with short pulse spacings, e.g., within a laser burst. As a result, for example, on-the-fly modification of the substrate can be made possible particularly reliably, in particular using a plurality of offset laser pulses, each of which modifies the substrate in a separate depth portion on a continuous trajectory within the substrate, primarily without a change in speed, deceleration or stopping of the axes during a structuring process. This holds true particularly in the cases in which the substrate is moved relative to a line focus at a travel speed of less than or equal to 2 m/s and/or with intra-burst pulse spacings of 25 ns or less. The diameter of the modification itself (for example 1-10 μm) can be used here as a comparison variable, for example.

As already explained above, it is possible to attain a purely lateral offset using the proposed means which deflect the beam, by way of deflection that two positions situated one behind another in the beam path, wherein the angle produced by the first deflection is compensated for by the second deflection. The synchronization of the deflection elements with respect to one another should preferably be taken into consideration in this case.

Alternatively, or supplementarily, it can also be provided that influencing the laser beam by at least the at least one phase mask is carried out time-dependently and the energy distribution, in particular the shape and/or position thereof, is changed time-dependently as a result.

By performing Time -dependent influencing, it is possible to move the energy distribution for example along the trajectory of the focus within the material. It is thus advantageously possible, in one embodiment, to temporally shift the maximum of the energy distribution and thus to reliably perform the modification of the substrate even along a large thickness region.

This is advantageous, for example, if the line focus is not able to provide along the entire thickness region a sufficiently high energy distribution in the substrate material for introducing a modification into the substrate material.

An energy distribution with which a threshold value required for the modifications is reached or exceeded along a portion of the focus trajectory can thus be moved within the substrate.

If for example the pulse energy is not sufficient for attaining along the entire thickness region and energy density greater than a threshold value required for modifications, this is a reliable and simple possibility for nevertheless fashioning a symmetrical separating surface even in the case of correspondingly large thicknesses.

This is therefore advantageously an application of dynamic influencing.

Alternatively, or supplementarily, it can also be provided that the laser beam is influenced by different regions of the phase mask at different, preferably directly successive, time periods, and in particular the laser beam, the centroid of the beam cross-section existing in the plane of the phase mask, has different incidence points on said phase mask during the different time periods.

By way of example, for this purpose, the offset can be controlled over time, i.e., the incidence point of the laser beam (or that of the centroid of the beam cross-section existing in the plane of the phase mask) on the phase mask. The abovementioned means are suitable for this by virtue of their changing the offset time-dependently.

By way of example, the phase mask can be moved time-dependently relative to the laser beam, such that preferably 4 different points in time the offset is different within the horizontal plane of symmetry of the phase distribution.

Alternatively, or supplementarily, it can also be provided that the time-dependent influencing results in the energy distribution, preferably at least one maximum of the energy distribution, being moved within the substrate, in particular from a larger to a smaller depth and/or along the focus trajectory within the substrate.

Besides the general possibility—already described above—for shifting the energy distribution and thus being able to modify even large thickness regions, it is Alternatively, or supplementarily advantageous to produce the modification by way of a corresponding movement of the energy distribution, or of its maximum or centroid, for example from the bottom to the top, i.e. in particular from the side of the substrate facing away from the laser toward the side of the substrate facing the laser, in the substrate. As a result, preferably the location of the current modification moves from previous modifications. Consequently, the line focus at the current location is not influenced by modifications that have already been introduced into the substrate. As a result, the modification can be introduced into the substrate very reliably.

In this case, in the substrate “at the bottom” can be, in the beam direction, the location which is furthest away from the laser source and which the laser beam passes through in the substrate. In this case, in the substrate “at the top” can be, in the beam direction, the location which is closest to the laser source and which the laser beam passes through in the substrate.

In this regard, the pulse from a radiation source can preferably also be divided temporally into two or more parts which impinge on the phase mask at different locations with a small time offset. For this purpose, therefore, a single pulse is divided temporally, and, for example, the first part is directed onto a first position of the phase mask and the second part is directed onto a second position of the phase mask. In this case, the deflection can preferably be achieved by one of the means mentioned above, in particular by way of separate beam paths (also as a fixed set-up, then preferably by way of mirrors). Alternatively, or supplementarily, the SSTF described below is also preferred in this context.

Therefore, this type of dynamic focusing can be highly preferred, even if the pulse energy is sufficient for the modification throughout the entire depth of the material. This is because in these situations the advantage of dynamic focusing is that the manifestation of the material modification in the lower part of the substrate is not obstructed by the plasma in the upper part of the substrate.

However, this form of dynamic focusing can also be of particular interest if the available pulse energy is not sufficient for modifying the substrate along the entire thickness thereof all at once.

This is because precisely in the case of thicker substrates, but also very generally, the entire damage zone can thus be constituted in the substrate by way of a plurality of individual submodifications, attained in each case by a laser pulse at a different position on the, in particular cubic, phase mask. It is particularly advantageous in this case to begin with the deepest individual submodification (furthest away from the laser source in the beam direction) in the substrate material, and to progressively elevate the position in the substrate.

The proposed method is therefore preferred precisely in the case of substrates having a thickness of 500 μm or greater, preferably of 1 mm or greater, preferably of 3 mm or greater, preferably of 5 mm or greater, preferably of 7 mm or greater.

Smaller laser sources can thus be used.

Alternatively, or supplementarily, it can also be provided that influencing the laser beam by at least the at least one phase mask comprises changing the intensity distribution of the laser beam, in particular within a pulse duration, on the phase mask, in particular at the location of the incidence of the beam on the phase mask, in particular shifting said intensity distribution spatially on said phase mask.

As it were a region of elliptic shape on the phase mask is thus illuminated differently in a time-dependent manner. Since this can take place without mechanical movement, but rather by way of modulation of the laser beam intensity, this is possible very reliably. Moreover, undesired effects that obstruct or prevent targeted adjustment of the energy distribution in the material can be prevented by controlling the temporal development of the energy distribution in the material.

This simultaneous spatio-temporal pulse shaping (SSTF) is therefore highly preferred.

Alternatively, or supplementarily, it can also be provided that by the energy distribution introduced by at least one part of the line focus, (a) the substrate is modified at least regionally in terms of a material property, such as, in particular, its density, its refractive index, its stress values and/or its etching rate, (b) microcracks are produced at least regionally in the substrate material, and/or (c) material is removed from the substrate and/or displaced at least regionally,

wherein preferably in a plurality of successive substrate regions in this way the substrate material is modified, removed and/or displaced along a straight or arbitrarily shaped contour, and in particular the substrate material is compressed into the surrounded substrate material.

By virtue of the substrate material thus being changed in terms of property, the planned separating surface is determined. Correspondingly, the corresponding side surface of the substrate parts is also determined as a result.

Removing substrate material from the substrate can take place for example by evaporating the material. Displacing substrate material can take place for example by compressing substrate material into the surrounded substrate.

The controlled energy distribution can therefore generally be regarded as a means by which the modification, including material removal or displacement, is attained in the substrate material. This is because the energy distribution interacts with the substrate material to yield the final modifications, in a manner that is not examined more specifically here and is of no further relevance to the understanding of the disclosure.

By carrying out a corresponding procedure in a plurality of regions of the subject, it is possible to attain a plurality of modified regions or regions with removed/displaced substrate material. These regions predefine as it were a corridor of damage, which at the same time also determines the planned separating surface. By way of example, the separation of the substrate into two substrate parts along the planned separating surface can be triggered and/or carried out by way of the substrate being influenced mechanically or thermally. By way of example, a crack can be produced in the corridor and made to propagate therein. Alternatively, or supplementarily, the substrate can be irradiated by an IR laser in order to initiate and/or carry out the separating process. CO₂ cleaving is also a preferred possibility for carrying out the separation of the substrate.

The different regions can be selected by way of a relative shift of substrate and line focus. If the shift of the substrate by one centimeter requires much more time than the length of the pulse duration of the laser (for example more than 100 times that), the shift can preferably take place continuously. Alternatively, or supplementarily, a maximum permissible travel speed v can also be ascertained using the relationship v=modification size/pulse spacing, wherein the modification size is the maximum extent of the modification to be introduced into the substrate material, and the pulse spacing is the intra-burst pulse spacing) 40 MHz) or, in the case of individual pulses, the spacing between two successive pulses (for example 1/100 kHz).

Preferably, the shift takes place continuously at a speed of 10 m/s less, preferably of 5 m/s or less, preferably of 2 m/s or less.

A contour is understood here to mean that curve which is described by the incidence points of the laser beam on the surface of the substrate. The contour can for example be rectilinear or circular, or have some other, in particular arbitrarily curved, course.

In one embodiment, the, in particular maximum, diameter of the material modification or of the region with removed or displaced material, in particular in a cross-sectional plane perpendicular to the main extension direction of the modification, is between 1 micrometer and 100 μm, preferably between 1 μm and 50 μm, even more preferably between 1 μm and 20 μm, even more preferably between 1 μm and 10 μm.

Alternatively, or supplementarily, it can also be provided that two or more line foci of two or more laser beams are formed correspondingly within the same region in the substrate, preferably at least partly in parallel and/or at least partly sequentially over time, and the energy distribution introduced into the substrate by them is controlled correspondingly in each case,

wherein preferably (a) the energy distributions introduced by the individual line foci are different, in particular with regard to position and/or shape, wherein preferably the maxima of the individual energy distributions exist at different positions within the substrate, and/or (b) the trajectories of the two or more line foci are congruent.

If a plurality of laser beams is used, an individual modification can be produced very rapidly even in thick substrates. This is because components of the optical set-up do not need to be moved mechanically in order to influence an individual laser beam, in particular in order to shift the energy distribution or the maximum thereof in the substrate. Instead, by way of example, a first laser beam can have a maximum of the energy distribution in the lower region of the modification, and a second laser beam can have a maximum of the energy distribution in the upper region of the modification (wherein “at the top” is preferably where the laser beam is incident on the substrate).

In one embodiment, a plurality of beams is used to modify the substrate in parallel at two or more positions spaced apart from one another laterally.

If the beams, in particular pulses, from different laser sources are used, then the laser sources are preferably laser sources of identical type. Particularly uniform modifications are thus achievable.

Alternatively, or supplementarily, it can also be provided that the orientation of at least one portion of the line focus within the substrate relative to the main propagation direction of the laser beam in the substrate is adjusted by controlling the energy distribution within the substrate and furthermore by adapting the focus position in the substrate material, wherein preferably adapting the focus position takes place by changing the distance between a focusing optical unit and the substrate and/or the thickness of the substrate is less than half the length of the line focus potentially possible for a given optical set-up along the thickness extension of the substrate, wherein preferably the pulse energy and/or the beam diameter are/is chosen such that the substrate is modified in its entire depth or is not modified in its entire depth.

Since the moving of the maximum of the energy distribution away from the vertex point of the focus trajectory, in particular Airy focus trajectory, is accompanied by a change in the local alignment of the line focus relative to the beam propagation direction or substrate surface, an adaptation of the angular alignment of the damage zone in the material can be performed with a combined beam offset, as has been described above for preferred embodiments, and a simultaneous adaptation of the focus position in the substrate material, that is to say for example with the abovementioned change in the distance between focusing optical unit and substrate or a change in the focal length of the focusing optical unit.

In this way, in the case of thin glasses, a small segment of the Airy trajectory can be used to produce a, at least approximately, straight line focus at an adjustable angle with respect to the propagation direction.

Advantageously, therefore, by adapting the focus position in the substrate material, in particular by changing the distance between a focusing optical unit and the substrate, it is possible to adjust a translation of the line focus in the substrate, and/or by adapting the beam offset on either the phase mask and/or an optical unit, such as the focusing optical unit, it is possible to adjust a free orientation—at least within certain angular ranges—of the at least one portion of the line focus within the substrate relative to the main propagation direction of the laser beam in the substrate.

Together with the orientation of the at least one portion of the line focus, the orientation of the modification introduced into the substrate material advantageously changes as well. As a result, preferably, by adapting the offset, a tilt of the modification in the substrate material can be attained and/or, by adapting the focus position, an offset along the laser propagation direction which accompanies the tilt can be compensated for and/or the vertical position of the tilted modification can be adapted and/or adjusted.

In this case, a “tilt” of the modification in the substrate material is preferably understood to mean a modification which was introduced into the substrate material under specific boundary conditions in regard to the optical set-up and also the laser parameters, and which has a spatial orientation which is different than a spatial orientation of a, in particular imaginary, reference modification, wherein the reference modification is introducible into the substrate material in conjunction with an adjusted offset of the laser beam on the phase mask and/or an optical unit, such as the focusing optical unit, under otherwise identical boundary conditions.

Advantageously, therefore, a tilt of the modification introduced into the substrate can be adjusted and/or attained by shifting the energy distribution along the trajectory of the line focus. Alternatively, or supplementarily, a tilt would also be conceivable by way of a tilt of the substrate, in particular in the static case.

It is preferred here if adapting the focus position in the substrate material is carried out time-dependently, in particular the focus position in the substrate material is changed time-dependently. This can take place for example by way of a time-dependent change in the distance between the focusing optical unit and the substrate. This is therefore advantageously an application of dynamic influencing. Optionally, it can be preferred for the beam offset on the phase mask and/or an optical unit, such as the focusing optical unit, also to be adapted in parallel. That is to say that focus position and offset our advantageously adapted in a manner dependent on one another.

Advantageously, a tilt of the modification is adjusted and/or carried out by shifting the intensity maximum of the energy distribution along the trajectory of the line focus. An asymmetrical manifestation of the material modification can advantageously be compensated for as a result.

It is preferred here for the substrate thickness along which the line focus is formed to be at least smaller than half the extent of the, in particular theoretically and/or practically, available focus trajectory in the glass thickness direction.

By way of example, substrates having a thickness of 500 μm or less, preferably of 300 μm or less, preferably of 100 μm or less, preferably of 50 μm or less, are particularly preferred here. Alternatively, or supplementarily, the thickness can also be between 300 mm and 1000 μm.

The curved line focus can be produced, in particular using the means mentioned above, for example with lengths of from more than 0.1 mm to more than 3 mm, preferably of between 0.1 mm and 5 mm, in particular of between 0.5 mm and 3 mm, and/or with a maximum deflection from the straight focal line of 500 μm, preferably of between 10 μm and 200 μm, in particular of between 20 μm and 80 μm.

The spatial shape of curvature and thus the spatial shape of the influenced substrate material are dependent on or concomitantly determinable by said maximum deflection, which can also be referred to as profile excursion.

For adjusting the maximum deflection or the profile excursion, the numerical aperture A=n*sin (ALPHA) of the focusing optical unit can be adjusted and/or adapted. The following generally holds true here: The larger the numerical aperture chosen for the focusing optical unit, the shorter the length of the focus formed becomes and—in the exemplary case of an Airy beam—the higher the curvature of the Airy beam in proximity to the focus.

For the curved line focus, this means that as the thickness of the substrate decreases, the local curvature of the line focus has to be increased in order to produce an appreciable profile excursion at the separating service.

Alternatively, or supplementarily, it can also be provided that:
(I) the line focus is a focus of an Airy beam,
(ii) the line focus has a maximum deflection from a straight course which is more than 20 μm, more than 40 μm, more than 60 μm, more than 80 μm or more than 100 μm,
(iii) the laser beam is emitted by a pulsed laser,
(Iv) the wavelength of the laser beam is selected from the wavelength range of between 200 nm and 1500 nm, preferably the wavelength is 343 nm, 355 nm, 515 nm, 532 nm, between 750 nm and 850 nm, 1030 nm and/or 1064 nm, the microscope objective or the Fourier lens of a focusing optical unit by which preferably the laser beam is focused onto the substrate has a focal length of 10-20 mm, the coefficient of the cubic phase (laser parameter beta) has a value of between 0.5×10³/m and 5×10³/m, the diameter of the raw beam (laser parameter c.30) has a value of between 1 mm and 10 mm, preferably of between 2.5 mm and 7.5 mm, preferably of between 2.5 and 5 mm, the pulse duration (laser parameter C) has a value of 0.1-10 ps, the pulse energy (laser parameter Eₚ) has a value of between 1 and 1.500 μJ, preferably of between 30 and 500 μJ, in particular 474 μJ, and/or the number of pulses in the burst (laser parameter N) has a value of between 1 and 200, preferably of between 1 and 100, in particular of between 1 and 8,
and/or
(v) the pulse energy of the laser is only sufficient to modify the substrate in terms of at least one material property or to remove or to displace material from the substrate along a specific portion of the line focus, wherein the portion is shorter than the extent of the substrate region which is intended to be modified in terms of its material property or which is intended to be removed or displaced.

An Airy beam can be generated reliably and has a curved line focus.

A laser beam whose line focus is used in the present case can be directed and controlled along an optical path using known means. The line focus can be adjusted and adapted using various means, such as optical elements. Thus, an electromagnetic field can be generated within the substrate body, which electromagnetic field can assume any spatial shape that is attainable using beam shaping and beam influencing means. Preferably, and Airy beam is generated.

A laser beam with a line focus thus constitutes an extremely flexible means for modifying the substrate in a curved region.

When processing substrate bodies by a laser, it is generally necessary to differentiate between processes of linear and nonlinear absorption. Linear absorption is present if the material to be processed is partly or completely absorbent for the wavelength of the laser used (e.g.: absorption of CO₂ laser radiation in glass), such that the strength of the interaction can correspondingly be adjusted by way of laser wavelength, laser energy, pulse duration and the like. That should be differentiated from the processes of nonlinear absorption, in which the material to be processed initially has no absorption in the range of the laser radiation used, i.e., is transparent to the laser wavelength(s). By generating so-called ultrashort laser pulses (in this case, typical pulse lengths vary in the range of 10 ps to 100 fs, in particular in the range of 1 ps to 100 fs), however, sufficiently high intensities in respect of which nonlinear optical effects become relevant can be generated in the substrate material by the laser. These effects can comprise for example, a change in the effective refractive index or the generation of a plasma in the substrate material. If enough energy is deposited with suitable distribution in the material, then the laser beam produces a permanent influence in the material. The local changes in the material that are produced as a result range from permanent changes in the refractive index, change in the etching behavior (selective laser etching) through to the production of cracks and channels in the substrate, in each case in a manner dependent on the interplay of the laser and material parameters, and in a manner delimited to at least one region of the laser focus formed in the material.

The inventors have assumed previously that the energy deposited in the substrate can be regarded firstly as the result of the nonlinear interaction between the electromagnetic field of the laser pulse and the substrate material, and secondly as the cause of the modification in the substrate. Without consideration of the specific damage mechanisms in the material, the deposited energy, which can be simulated using suitable models for the nonlinear laser pulse propagation, can therefore be used as a representative of the manifestation of the material modification.

For example, the critical intensity for a glass substrate in order to bring about therein a nonlinear change in material properties, but in particular a plasma suitable for material processing, is at least 10¹³ W/cm². In one embodiment, the substrate material comprises glass and the electromagnetic field of the laser has a field strength of at least 10¹³ W/cm², preferably of at least 5×10¹³ W/cm², preferably of at least 10¹⁴ W/cm², most preferably of at least 5×10¹⁴ W/cm². Optionally, the electromagnetic field has a field strength of a maximum of 10¹⁶ W/cm².

A possible set-up for producing a curved line focus in the manner according to the disclosure can be configured as follows, in principle: The laser beam from an ultrashort pulse laser impinges on a diffractive optical element (DOE), which adapts the phase of the incident laser beam (laser pulse) by imposing a phase, such as a cubic phase. The beam is subsequently focused onto the substrate wanted to be structured by a microscope objective and/or a Fourier lens. Depending on the phase distribution established downstream of the DOE, the imaging objective now no longer produces a straight focal line, but rather a curved focal line. In one embodiment, the secondary maxima of the Airy beam can also be suppressed. In this case, the intensity ratio of the primary focus to the rest of the beam can be optimized (1.2-10). That can be realized for example by way of the non-radially symmetrical apodization in the Fourier plane by a stop.

By way of example, a DOE used as a phase mask has a diameter of 5-15 mm, preferably 9 mm, wherein the DOE lies in the “front focal plane” of the microscope objective or the Fourier lens. Preferably, the DOE (or in general terms the phase mask) has a working distance from the relevant lens which is equal to the focal length of the lens and/or is between 2-15 mm, preferably 5 mm. If, for a microscope objective, the “front focal plane” lies in the objective itself, the minimum (structurally governed) distance should preferably be chosen in these cases.

By way of example, an Airy beam can be used in the present case. An Airy beam is particularly well suited to an asymmetrical/lateral beam feed.

Moreover, an Airy beam can be produced particularly simply and efficiently. By way of example, an Airy beam can arise as imaging of a beam with a cubic phase, which is produced in particular either directly by a phase mask (DOE or SLM) or by a set-up with cylindrical lenses.

As pulse energy (laser parameter Eₚ) it is possible to choose a value of 300 μJ, for example; as the number of pulses in the burst (laser parameter N) it is possible to choose a value of 2, for example; and/or as pulse duration (laser parameter C) it is possible to choose a value of 5 ps, for example. Optionally, the focal length of the optical unit can be f=10 mm and/or a x2.0 beam expander (particularly in the case of an input Gaussian beam having a diameter of 10 mm) can be provided.

By way of suitable selection of the optical set-up (in particular definition of the vertical distance between the focusing optical unit and the substrate material to be processed, i.e. the focus position and focus length), in this way curved modifications can be produced in the interior or else one of the two or both large services (bottom and/or top outer surface) in a piercing manner in the substrate material.

If the pulse energy is greater than a threshold value dependent on the material of the substrate, a nonlinear interaction between laser and material can take place which can result in the modifications discussed. Therefore, in one embodiment, it is preferred for the pulse energy to be greater than a threshold value dependent on the material of the substrate so that a nonlinear interaction between lace and material takes place.

Alternatively, or supplementarily, it can also be provided that the regions that are modified within the substrate are opened by producing a mechanical and/or thermal stress and/or by an etching method, in particular in order to produce a through hole and/or a blind hole within the substrate material,

and/or
that they are opened along a closed contour and/or along a modification proceeding from substrate side to substrate side by way of mechanical, thermal and/or chemical processes, in particular in order to produce an inner or outer contour with a shaped side surface.

Alternatively, or supplementarily, it can also be provided that at least during the controlling of the energy distribution, at least one auxiliary substrate is arranged at the substrate and the line focus extends at least partly into the auxiliary substrate, wherein preferably two or more auxiliary substrates are arranged at the substrate, in particular at opposite sides of the substrate, and the line focus extends at least partly into two or more auxiliary substrates.

Preferably, the auxiliary substrate is composed of the same material as the substrate.

Such an auxiliary substrate makes it possible to avoid or at least considerably reduce ablation portions or ablation effects on the free substrate surfaces in the case of a piercing line focus.

By way of example, in one embodiment, the substrate to be structured can be processed jointly with an auxiliary substrate applied by wringing, bonding and/or ultrashort pulse welding, such that during the processing firstly only internal influences are produced and these are exposed as it were by removal of the auxiliary substrate in a further process step (describable as debonding, for example).

By providing an auxiliary substrate, it is thus possible, even in the region of the substrate near the surface, for the energy distribution and/or the substrate to be influenced in a particularly targeted manner in line with the stipulations. This is because owing to the auxiliary substrate the line focus can also go beyond the substrate, without the course of the line focus being impaired or appreciably impaired. This ensures that the line focus does not deviate from the desired shape even in the region of the substrate near the surface, and that the energy distribution can be adjusted in line with the stipulation and/or the substrate material can be spatially influenced in line with the stipulation.

Particularly if the auxiliary substrate and the substrate are composed of identical material, this ensures that at the interface between them there is a seamless and primarily offset-less transition of the line focus.

Afterward, the auxiliary substrate(s) can be removed from the substrate. The actual substrate with possibly influenced substrate material is thus exposed again.

In other words, if the auxiliary substrate is removed again, tidy influencing as far as the exterior surface of the substrate can be attained in the substrate.

One or more auxiliary substrates can be provided.

The auxiliary substrate(s) can surround the substrate, as it were enclosing it from one or more sides.

The auxiliary substrate reliably prevents accumulations of substrate material from occurring in the edge region of a surface owing to ablation effects.

Alternatively, or supplementarily, it can also be provided that the line focus, and preferably the modified material region of the substrate, is enclosed completely within the substrate, in particular at least during the controlling of the energy distribution,

and wherein preferably the method furthermore comprises at least regionally removing material from the substrate, in particular along the main extension direction of the line focus within the substrate, and thereby rendering the modified material enclosed in the substrate accessible at least partly and/or regionally from outside, in particular carrying out the removing of material from the substrate by etching.

By virtue of the line focus thus lying completely within the substrate, ablation portions or ablation effects on the—both original and obtained—surfaces of the substrate can be reliably avoided.

Specifically, the proposed features allow the deposition of energy and the influencing of substrate material only in a region which lies in the interior of the substrate; which in other words is not accessible externally. As a result, the course of the line focus is not impaired or not appreciably impaired. This ensures that the line focus does not deviate from the desired shape, and/or that the substrate material is spatially influenced in line with the stipulation.

Afterward, substrate material can be removed from the substrate until, for instance, the influenced substrate material is reached (or else beyond that). By way of example, a corresponding etching process has proved to be advantageous for this since it can be carried out precisely and efficiently. A new surface, for example at least one new, at least temporary, outer surface of the substrate, can be formed in this way. Removing the substrate material makes the influenced material region accessible externally. As a result, it is possible, for instance, to subsequently remove the influenced substrate material.

In this way, it is possible to attain very reliably defined influenced material regions in the substrate which extend as far as the surface of the finally processed substrate. This in turn also allows a tidy surface to be realized.

By way of example, removing material from the substrate results in at least one, preferably both, outer surface(s) of the substrate being changed. A displacement of the outer surface can take place here, for instance along the main extension direction of the line focus.

In this case, the main extension direction of the line focus can run for example perpendicularly to an original and/or modified outer surface of the substrate.

Alternatively, or supplementarily, it can also be provided that controlling the energy distribution within the substrate furthermore comprises (i) the laser beam having a spherical aberration, in particular at least in the region of the line focus, and/or (ii) adjusting a spherical aberration of the laser beam, in particular at least in the region of the line focus.

In this respect, it has been recognized, surprisingly, that a more uniform and more extensive energy distribution in comparison with the original Airy beam can be introduced in the substrate by virtue of the laser beam having a spherical aberration. A better manifestation of the region modified in the substrate can be attained as a result. Thus, undesired damage of the substrate material can be reduced or even completely avoided, and/or the energy of the laser pulse can be reduced for a target energy distribution and target modification predefined in respect of manifestation.

Moreover, advantageously, by adjusting the spherical aberration it is possible to adjust a position of the maximum intensity of the energy distribution along the, preferably positionally fixed, line focus trajectory, and/or by changing the spherical aberration it is possible to adapt, in particular shift, a position of the maximum intensity of the energy distribution along the, preferably positionally fixed, line focus trajectory.

That makes it possible particularly advantageously to attain an at least regional and/or sectional homogenization of the intensive, in particular along the trajectory of the line focus. Specifically in particular without changing the trajectory of the line focus, in particular the primary maximum thereof.

The spherical aberration preferably has the unit 12.5/f³, where f is the focal length of the imaging system.

When this application refers to the laser beam having a spherical aberration, then that is preferably understood to mean that the light rays of the laser beam do not converge at a specific point and/or that one or more rotationally symmetrical phases of even power >2 are present, for example an additional fourth-order phase term, which lead to a change in the effective focal length along the radius of the optical unit.

Advantageously, the spherical aberration of the beam could be introduced by an optical unit comprising a lens having spherical aberration whose phase satisfies the following equation:

$${ϕ}_{lens} ( ρ ) = k 0 * ( \frac{{ρ}^{2}}{2 f} + a {ρ}^{4} )$$

Alternatively, or supplementarily, it can also be provided that the laser beam, preferably outside the substrate and/or upstream of the substrate, propagates through an optical element with spherical aberration, and as a result preferably the spherical aberration of the laser beam is at least partly adjusted, in particular at least in the region of the line focus.

This is a particularly simple and nevertheless efficient possibility for adjusting and controlling the spherical aberration of the laser beam.

Alternatively, or supplementarily, it can also be provided that the fourth-order spherical aberration has a strength of 0.02/(f*w0\hat{ }2) or more, wherein f is the focal length of the imaging system and w0 is the diameter of the laser beam.

This is particularly advantageous for typical energy distributions for introducing modifications into glass substrates.

Alternatively, or supplementarily, it can also be provided that the spherical aberration results in a lengthening of the focus formed within the substrate by 5% or more, preferably by 10% or more, preferably by 15% or more, preferably by 20% or more, preferably by 25% or more, preferably by 30% or more, preferably by 35% or more, preferably by 40% or more, preferably by 50% or more, preferably by 60% or more, and/or by 100% or less, preferably by 70% or less, preferably by 50% or less, preferably by 30% or less, wherein preferably the focus length exists along a portion of the laser beam trajectory at which the line focus has an intensity which is 75% or more, 80% or more, 85% or more or 90% or more, of the maximum intensity of the line focus.

For this purpose, it is possible for example to compare the length of the focus formed within the substrate (namely of the line focus) with and without adjusted and/or controlled spherical aberration.

Alternatively, or supplementarily, it can also be provided that the spherical aberration results in a lengthening of the modified substrate material by 5% or more, preferably by 10% or more, preferably by 15% or more, preferably by 20% or more, preferably by 25% or more, preferably by 30% or more, preferably by 35% or more, preferably by 40% or more, preferably by 50% or more, preferably by 60% or more, and/or by 100% or less, preferably by 70% or less, preferably by 50% or less, preferably by 30% or less, wherein preferably along the length there exists a modification intensity for which the modification has an intensity which is 75% or more, 80% or more, 85% or more or 90% or more, of the maximum intensity of the modulation.

In this regard, the difference can also be established directly on the processed substrate.

Alternatively, or supplementarily, it can also be provided that the spherical aberration of the laser beam is varied over time, in particular in the region of the line focus, in particular by way of a temporal variation of the incidence point of the laser beam on the phase mask and/or an optical element, such as a microscope objective, of the optical set-up.

A temporal depth variation of the material modification can be achieved particularly simply as a result. By way of example, the material modification can be formed “from the bottom to the top” by a procedure that involves changing the spherical aberration and, as a result, time-dependently lengthening the line focus and with it the energy distribution and/or shifting the intensity maximum thereof.

Alternatively, or supplementarily, it can also be provided that the center point of the laser beam incident on the optical element is incident on the optical element at least at times with an offset with respect to the optical axis of the optical element, wherein preferably the offset is varied over time.

This can be realized particularly simply, for example by the laser beam and/or the optical element being moved relative to one another.

Alternatively, or supplementarily, it can also be provided that a constant and/or maximum offset of 20 mm or less, preferably of 15 mm or less, preferably of 10 mm or less, preferably of 5 mm or less, preferably of 3 mm or less, preferably of 2.5 mm or less, preferably of 2 mm or less, preferably of 1.5 mm or less, preferably of 1 mm or less, of 0.001 mm or more, preferably of 0.003 mm or more, preferably of 0.01 mm or more, preferably of 0.1 mm or more, preferably of 1 mm or more, preferably of 5 mm or more, preferably of 10 mm or more, preferably of 15 mm or more, and/or of between 0.001 mm and 20 mm, preferably of between 0.001 mm and 10 mm, preferably of between 0.003 mm and 10 mm, preferably of between 0.003 mm and 5 mm, preferably of between 0.003 mm and 2 mm, preferably of between 0.003 mm and 1.5 mm, is adjusted.

Alternatively, or supplementarily, it can also be provided that the optical element is a lens, wherein the lens has a spherical curvature preferably at least regionally.

This is a particularly simple and advantageous possibility for equipping the laser beam with a spherical aberration in a controlled manner.

Alternatively, or supplementarily, it can also be provided that the spherical aberration is a fourth-order or higher-order spherical aberration.

Particularly good results were obtained by this means.

Alternatively, or supplementarily, it can also be provided that the spherical aberration is a spherical aberration according to Zernike polynomials with indices m=0 and n=2k for integral k>2.

Particularly good results were obtained by this means.

Alternatively, or supplementarily, it can also be provided that the spherical aberration and the influencing of the laser beam by the phase mask are coordinated with one another, in particular by the, preferably temporally varying, incidence point of the laser beam on the optical element and the, preferably temporally varying, incidence point of the laser beam on the phase mask being coordinated with one another.

The interplay of two independent mechanisms makes it possible to achieve a particularly good control of the energy distribution introduced in the substrate.

Alternatively for supplementarily, it can also be provided that the energy distribution, the intensity and/or the intensity distribution of the back end portion of the line focus along the main extension direction of the line focus is adjustable, in particular changeable, such as by magnification, by way of the adjusting of the spherical aberration.

This advantageously exploits the effect that the spherical aberration leads to asymmetrical influencing of the line focus and the energy distribution (in particular manifested on only one side of the original focus). In this regard, the effect can be exploited in order to compensate for a preferred energy deposition owing to nonlinear effects upstream of the linear focus by placing the amplified region downstream of the linear focus.

Alternatively, or supplementarily, it can also be provided that the positioning of the energy distribution along the line focus, in particular along the, preferably positionally fixed, trajectory of the line focus, is changeable and/or adjustable by way of the adjusting of the spherical aberration.

Alternatively, or supplementarily, it can also be provided that controlling the energy distribution within the substrate furthermore comprises changing the wavelength of the laser beam time-dependently, in particular continuously or discretely, and wherein preferably within the beam path of the laser beam, preferably upstream of the substrate, an optical element is provided which refracts the laser beam wavelength-dependently

The optical element can be a prism, for example, which is preferably placed in the beam path of the laser beam.

Alternatively, or supplementarily, it can also be provided that the laser beam has an at least intermittently elongated, in particular rectangular or oval, for example elliptic, beam cross-section at least in portions, in particular in the plane of the phase mask, wherein preferably the beam cross-section is changed over time, in particular between circular and oval.

With a rectangular beam cross-section, it is possible to attain a particularly constant intensity distribution along the propagation.

It has been recognized, surprisingly, that a laser beam having a cross-section that deviates from a circular area (primarily on the phase mask) can have a line focus which can have reduced secondary maxima. As a result, undesired modifications in the substrate that are caused by secondary maxima can be avoided or at least reduced.

Preferably, the laser beam in this case is an elliptic beam. An elliptic beam is preferably characterized in that the beam diameters along two mutually orthogonal principal axes deviate from one another. An elliptic being can be generated by adapting, in particular expanding or reducing, the beam diameter of a rotationally symmetrical beam in one spatial direction by corresponding optical units, e.g., a telescope composed of cylindrical lenses.

The proposed formation of the laser cross-section makes it possible to increase the contrast of the line focus since the intensity of the primary maximum can be increased in comparison with the intensity of each of the secondary maxima. Moreover, an orientation of the secondary maxima was observed, with the secondary maxima running parallel to the planned separating surface to the greatest possible extent. As a result, the secondary maxima do not influence the introduction of the modification in the substrate, or the influence it only slight.

Moreover, the proposed formation of the laser cross-section makes it possible to attain secondary maxima of the line focus which blur to a certain extent, such that adjacent secondary maxima merge into one another. A particularly good quality of the cut surface can be attained as a result.

In conjunction with the proposed formation of the laser cross-section, it is advantageously possible to attain a crack orientation within the substrate upon or for the purpose of forming the separating surface, or upon or for the purpose of dividing the substrate, which substantially runs along the modifications in the substrate that are produced by the primary maxima of the line focus. Alternatively, supplementarily, the crack orientation is collinear with respect to the desired cut. A particularly good quality of the cut surface can be attained in each case as a result.

Preferably, in this case, the material modifications caused by the secondary maxima of the line focus, in particular in a cross-sectional plane perpendicular or parallel to an outer surface of the substrate, run substantially parallel to the planned cut surface and/or linearly. This can be attained for example by a suitable orientation of substrate and laser beam (in particular with an elongated beam cross-section) with respect to one another.

Preferably, in this case, the material modifications caused by the secondary maxima of the line focus are arranged within the substrate material in a manner resembling an onion skin with respect to one another.

Alternatively, or supplementarily, it can also be provided that a plurality of material modifications are introduced into the substrate, wherein the distance between adjacent material modifications, in particular the distance between the centroids of the material modifications and/or in a cross-sectional plane parallel to an outer surface of the substrate, is 1 μm or more, preferably 3 μm or more, preferably 5 μm or more, preferably 7 μm or more, preferably 10 μm or more, preferably 15 μm or more, preferably 20 μm or more.

Particularly in conjunction with the laser beam having a cross-section that deviates from a circular area, it is possible, surprisingly, to attain a particularly reliable formation of a separating surface, despite comparatively large distances (so-called “pitches”) between adjacent modifications of, for example, 1 μm or more and preferably even of 10 μm or more, of 20 μm or more, of 30 μm or more, of 40 μm or of 50 μm or more. In the case of such relatively large distances, it is possible to avoid or at least reduce any influencing of the line focus by an adjacent modification, introduced in particular with a time offset or at the same time.

Consequently, the proposed distance thus makes it possible to avoid or at any rate reduce interactions between adjacent regions in the substrate with modifications.

In particular, the outliers of the modifications manifested in laterally angular/arrowlike fashion (in particular caused by the secondary maxima of the line focus), as a result of a corresponding distance, overlap generally only to a reduced extent or not at all. By choosing an elongated beam cross-section, these outliers can even be reduced again, and so together with the larger distance of adjacent pitches a reliable material modification can take place at a plurality of locations. This makes it possible to ensure that the propagation of the laser beam in the material is not disturbed, or is only slightly disturbed, by preceding and/or adjacent modifications.

The object is achieved by the disclosure in accordance with a second aspect by virtue of there being proposed a substrate comprising at least one first outer surface, at least one second outer surface, preferably running parallel to the first outer surface, and at least one, in particular laser-broken, side surface which extends preferably at least regionally between the first and second outer surfaces,

wherein in a cross-sectional plane of the substrate that is spanned by a plane having at least one normal vector of the side surface and a normal vector of the first outer surface, the contour of the side surface has a vertex point arranged between the two outer surfaces, and wherein preferably (i) the vertex point (a) is arranged centrally between the two outer surfaces, and/or (b) is arranged at a, in particular vertical, distance from the central position between the two outer surfaces, and in particular the, in particular vertical, distance along a direction parallel to the normal vector of the first outer surface is (aa) more than 0.1%, preferably more than 1%, preferably more than 5%, preferably more than 10%, preferably more than 20%, preferably more than 30%, preferably more than 40%, preferably more than 45%, of the thickness of the substrate, (bb) less than 50%, preferably less than 45%, preferably less than 35%, preferably less than 25%, preferably less than 15%, preferably less than 10%, preferably less than 5%, preferably less than 3%, preferably less than 1%, of the thickness of the substrate and/or (cc) between 0.1% and 49%, preferably between 0.1% and 10% or between 1% and 40%, preferably between 5% and 30%, preferably between 10% and 25%, of the thickness of the substrate, (ii) the side surface is height-modulated at least regionally, in particular has a wavy and/or spherical-cap-shaped structure, preferably along the main extension direction of the side surface and/or perpendicularly thereto, and/or (iii) the substrate has a curved modification with a course according to at least one portion of a trajectory of an Airy beam.

A height modulation has proved to be advantageous since it contributes to an increased strength of the surface.

In this case, the contour of the side surface is preferably understood to mean the, in particular linear, course of the side surface in the cross-sectional plane.

The object is achieved by the disclosure in accordance with a third aspect by virtue of there being proposed a substrate comprising at least one first outer surface, at least one second outer surface, preferably running parallel to the first outer surface, and at least one laser-broken side surface which extends preferably at least regionally between the first and second outer surfaces, wherein in a cross-sectional plane of the substrate that is spanned by a plane having at least one normal vector of the side surface and a normal vector of the first outer surface, the contour of the side surface has a vertex point arranged between the two outer surfaces, and wherein the vertex point is arranged centrally between the two outer surfaces and/or is arranged at a, in particular vertical, distance from the central position between the two outer surfaces, wherein the vertical distance along a direction parallel to the normal vector of the first outer surface is (i) more than 0.1%, preferably more than 1%, preferably more than 5%, preferably more than 10%, preferably more than 20%, preferably more than 30%, preferably more than 40%, preferably more than 45%, of the thickness of the substrate, (ii) less than 50%, preferably less than 45%, preferably less than 35%, preferably less than 25%, preferably less than 15%, preferably less than 10%, preferably less than 5%, preferably less than 3%, preferably less than 1%, of the thickness of the substrate and/or (iii) between 0.1% and 49%, preferably between 0.1% and 10% or between 1% and 40%, preferably between 5% and 30%, preferably between 10% and 25%, of the thickness of the substrate, wherein the thickness of the substrate is more than 500 μm, preferably more than 700 μm, preferably more than 1000 μm, preferably more than 1500 μm, preferably more than 2000 μm. In particular, it is proposed that the thickness of the substrate can be less than 10 cm, preferably less than 7 cm, preferably less than 5 cm, preferably less than 3 cm.

In the case of the first, second and/or third aspect of the disclosure, it can Alternatively, or supplementarily also be provided that:
(i) the substrate is transparent, is composed of glass and/or glass ceramic, has a first outer surface and/or has a second outer surface, which preferably runs parallel to the first outer surface and/or is situated opposite the latter,
and/or
(ii) the substrate has a thickness, preferably measured between the first and second outer surfaces,
   (a) of 10 μm or more, preferably of 30 μm or more, preferably of 50 μm or more, preferably of 70 μm or more, preferably of 100 μm or more, preferably of 300 μm or more, preferably of 500 μm or more, preferably of 700 μm or more, preferably of 1 mm or more, preferably of 3 mm or more, preferably of 5 mm or more, preferably of 7 mm or more, preferably of 10 mm or more,
   (b) of 10 mm or less, preferably of 7 mm or less, preferably of 5 mm or less, preferably of 3 mm or less, preferably of 1 mm or less, preferably of 700 μm or less, preferably of 500 μm or less, preferably of 300 μm or less, preferably of 300 μm or less, preferably of 200 μm or less, preferably of 100 μm or less, preferably of 70 μm or less, preferably of 50 μm or less, preferably of 30 μm or less, preferably of 10 μm or less,
   and/or
   (c) of between 10 μm and 10 mm, preferably of between 10 μm and 500 μm, preferably of between 50 μm and 200 μm.

### BRIEF DESCRIPTION OF THE DRAWINGS

Further features and advantages of the disclosure will become apparent from the following description, in which preferred embodiments of the disclosure are explained with reference to schematic drawings.

FIG. 1 shows an optical set-up for carrying out the method.

FIG. 2 shows a cubic phase mask.

FIG. 3 shows a substrate with a modified substrate region.

FIG. 4 shows the simulated profile of the line energy density along a line focus in a substrate for different pulse energies.

FIG. 5 shows the profile of the depth position of the experimentally determined maximum of the material modification for different pulse energies.

FIG. 6 shows how the offset of a laser beam on the cubic phase mask influences the position of the maximum of the focus intensity or of the energy distribution along the focus trajectory.

FIG. 7 shows the dependence between the offset of a laser beam on the cubic phase mask and the position of the maximum of the line energy density along the focus trajectory.

FIG. 8 shows the influence of the focal length of the focusing optical unit for a laser beam.

FIGS. 9a-c show different possibilities for producing a beam offset.

FIG. 9d shows a form of realization of the deflection optical unit in FIG. 9c.

FIG. 10a shows a cross-sectional view of a substrate with an enclosed curved modification region.

FIG. 10b shows a cross-sectional view of a substrate with an externally accessible modification region.

FIG. 10c shows a cross-sectional view of a processed substrate.

FIG. 11 shows a plan view of a processed substrate body.

FIG. 12 shows the substrate body from FIG. 11 with introduced modifications.

FIG. 13a shows an optical set-up for controlling in particular the spherical aberration.

FIG. 13b shows intensity profiles of a laser beam along a depth direction of a substrate for differently adjusted spherical aberrations.

FIG. 13c shows substrates with modifications introduced in conjunction with differently adjusted spherical aberrations and beam offsets.

FIG. 14a shows a cubic phase mask with a first beam cross-section of a laser beam and also a glass substrate with a modification caused by the laser beam.

FIG. 14b shows a cubic phase mask with a second beam cross-section of a laser beam and also a glass substrate with a modification caused by the laser beam.

### DETAILED DESCRIPTION OF THE DISCLOSURE

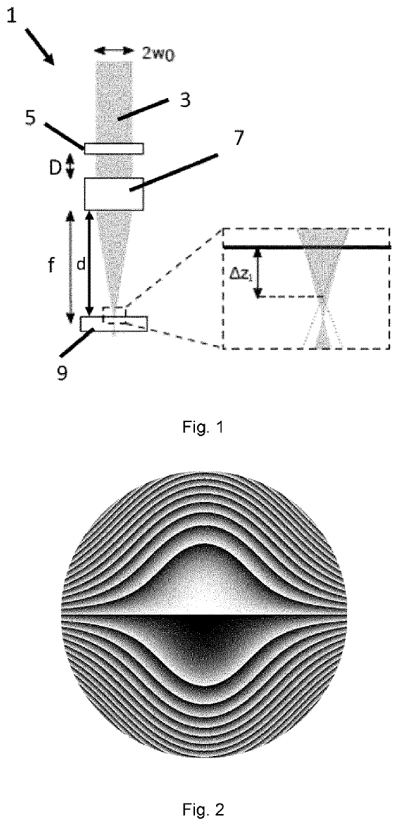

FIG. 1 shows an optical set-up 1 for carrying out the method in accordance with the first aspect of the disclosure.

The optical set-up 1 comprises a pulsed laser (not illustrated), which emits a laser beam 3 having a wavelength of 1030 nm. The laser beam 3 has a diameter of 2ω₀. The optical set-up furthermore comprises a cubic phase mask 5 and a focusing optical unit 7 having a focus length f of 10 mm, for example, said focusing optical unit being arranged in a manner spaced apart from said phase mask at the distance D. phase mask 5 and focusing optical unit 7 generate from the laser beam 3 an Airy beam having a curved line focus. For this purpose, the laser beam 3 passes through the phase mask 5 and subsequently the focusing optical unit 7.

A substrate 9 to be separated along a planned separating surface is arranged such that it is spaced apart from the focusing optical unit 7 at the distance d in such a way that the curved line focus of the laser beam 3 is formed within the substrate. In this case, the distance d is defined in relation to that outer surface of the substrate line which faces the laser source. The distance Δz₁ between the vertex point of the line focus and that outer surface of the substrate 9 which faces the laser source, and thus also the relative vertical position of the line focus within the substrate 9, is adjusted in the present case by the selection of the focal length f and/or by the selection of the distance d between the substrate 9 and the focusing optical unit 7. If the focal length f is increased or the distance d is decrease, then this causes a shift of the vertex point of the line focus, and thus of the entire curved line focus, away from that outer surface of the substrate 9 which faces the laser source—i.e. downward in FIG. 1. Conversely, a decrease in the focal length f or an increase in the distance d correspondingly causes a shift of the basic point of the line focus toward that outer surface of the substrate 9 which faces the laser source—i.e., upward in FIG. 1. In other words, the curved line focus can be moved through the substrate 9 along a depth region by variation of the distance d between the focusing optical unit 7 and that outer surface of the substrate 9 which faces the laser source, and/or by variation of the focal length f of the focusing optical unit 7. Consequently, the vertex point of the line focus can reliably be positioned for example centrally within the substrate 9, but also be positioned in a manner offset with respect thereto, at any desired location over the thickness of the substrate 9, i.e., for instance in a manner shifted toward the first outer surface. Of course, it is possible to adapt the focal length f and the distance d simultaneously in order to adapt the position of the vertex point, for example in the form of a reduction of the focal length f and an increase in the distance d.

If the line focus has an axis of symmetry, for example, then depending on the position of the vertex point in the substrate 9, said position being chosen in particular by way of adjusting the focal length f and/or the distance d, it is possible to produce symmetrical and asymmetrical material modifications over the thickness of the substrate 9 in the volume thereof. In particular, it is thus possible to produce modifications lying symmetrically, for example centrally in the substrate, such that the material modification is formed in a C-shaped fashion, for example. By contrast, if the line focus does not have an axis of symmetry, then it is possible to produce asymmetrical material modifications along the thickness of the substrate 9.

In this case, both symmetrical and non-symmetrical line foci lead to an advantageous material modification over preferably the thickness of the substrate 9 in the volume thereof, specifically in particular in a region within which the line focus is formed.

Besides the eccentric and thus asymmetrical positions—produced in this way—of the curved line focus, in particular of the vertex point thereof, in relation to the outer surfaces, it is hence preferably possible, by way of suitable selection of the focal length f, thus also to attain a positioning of the curved line focus in the substrate 9 which is central and thus symmetrical relative to the substrate thickness.

FIG. 2 shows a cubic phase mask such as can be used for the phase mask 5.

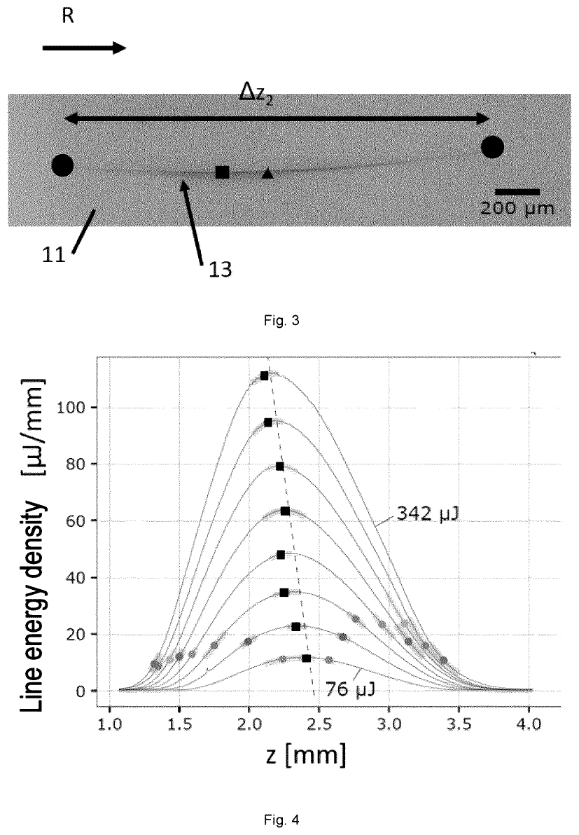

FIG. 3 shows a section through a detail of a substrate 11 with a substrate region 13 within which the substrate material was modified in terms of its refractive index by a curved line focus of an Airy beam.

Specifically, for this purpose, a pulse having a pulse energy of 342 μJ was used and, as described with regard FIG. 1, an Airy line focus was formed in the substrate 11, namely Borofloat® 33 from SCHOTT Germany. In this case, the laser beam had a main propagation direction R.

Along a portion of the line focus within which this introduced a sufficiently high energy density into the substrate everywhere in order to modify the material, the latter was modified. The circular areas at the two outer positions of the modification 13 identify the experimental detection limit of the modification 13. the two outer positions at a distance of Δz₂ along the depth region of the substrate 11, i.e., along the thickness of the substrate 11.

Moreover, the location at which the maximum of the energy distribution introduced by the line focus existed, and hence a maximum modification of the substrate material occurred, is also identified by a square in FIG. 3. The vertex point of the curved region is identified by a triangle. It is evident that the vertex point and the location of the maximum modification do not coincide.

FIG. 4 shows the simulated profile of the line energy density along a line focus in a substrate for different pulse energies. The effect of the pulse energy on the energy distribution in the substrate can thus be illustrated at least qualitatively.

In this regard, the location of the maximum line energy density along the focus of the (here simulated) Airy beam can be gleaned from FIG. 4, and within the substrate, for no pulse energy, corresponds to the position of the vertex point of the focus trajectory at 2.5 mm. The maximum modification in the substrate preferably arises at the location of the maximum of the energy distribution in the substrate.

As can be gleaned from the diagram in FIG. 4, for a pulse energy of 76 μJ (bottommost curve in the diagram), the line energy density has a maximum value of approximately 12 μJ/mm at a depth of approximately 2.4 mm. For a pulse energy of 342 J (topmost curve in the diagram), the line energy density has a maximum value of approximately 118 μJ/mm at a depth of approximately 2.1 mm. The maximum value of the line energy density is identified in each case by a square in accordance with FIG. 3. Consequently, the maximum value of the line energy density increases as the pulse energy increases. Moreover, the position of the maximum shifts in the direction of smaller depths as the pulse energy increases. In this case, the depth of 0 mm here is related to the substrate surface, i.e., that side of the substrate which faces the laser source.

Moreover, identified by two circular areas in each case, the depth region within which a modification would occur in an exemplary glass material can be discerned for each of the pulse energies. The modification proceeds along a depth region Δz of approximately 0.3 mm at a pulse energy of 76 μJ and along a depth region Δz of approximately 2 mm at a pulse energy of 342 μJ. In this case, owing to the curvature of the line focus that produces the modification, the length of said line focus between the two end points is greater than the distance Δz between the two points in the depth direction.

It can be established that as the energy of the pulse increases, the modification is manifested increasingly more asymmetrically and the location of maximum damage increasingly moves away from the vertex point of the Airy trajectory at 2.5 mm, toward smaller depths.

FIG. 4 thus illustrates how the energy distribution introduced into the substrate material by the line focus can be controlled by adjusting the pulse energy. Specifically for instance in the form of the maximum line energy density but also in the form of the length of the portion of the line focus along which the substrate material is modified in the text portion Δz.

With regard to FIG. 4, reference was made to the line energy density. The latter related here to the energy density along the focus trajectory of the Airy beam. A person skilled in the art will understand that this representation primarily serves for a better understanding of how a specific adjustment of the pulse energy affects the (spatial) energy distribution in the substrate. This is because the actual energy distribution in the substrate that produces the modifications is indeed concomitantly determine, in principle, by the line energy density of the focus as discussed here. However, further aspects can likewise influence the energy distribution and the substrate. By way of example, for instance having to absorption and defocusing by the plasma generated in the material, also called plasma shielding, there can be an upper value limit for the maximum of the energy density in the substrate, which limit cannot be exceeded even by increasing the line energy density of the focus; this effect is also referred to as intensity clamping.

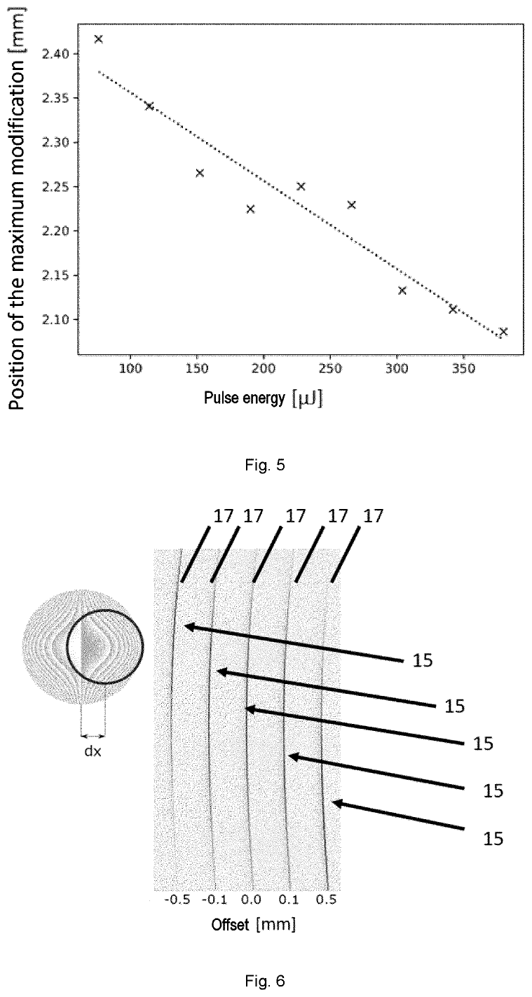

FIG. 5 illustrates the profile of the depth position of the experimentally determined maximum of the material modification for different pulse energies.

For this purpose, a plurality of modifications was introduced into a substrate, and a different pulse energy was adjusted for each modification. Afterward, for each modification, the position of the maximum of the modification was ascertained, where it can be assumed that this is also the position of the maximum of the line energy density. For all the modifications, the vertex point of the associated line focus was adjusted to an identical depth.

Once again it is possible to make primarily relative statements when comparing two positions. As the pulse energy increases, the depth of the maximum accordingly changes (toward smaller depths), the profile being approximately linear.

FIG. 6 shows how the offset of a laser beam on the cubic phase mask influences the position of the maximum of the focus intensity and thus effectively also that of the energy distribution in the substrate along the focus trajectory.

That is to say that the effect of an offset between input beam and cubic phase mask on the relative positioning of the maximum of the energy distribution and the vertex point of the Airy trajectory was investigated by simulation in the present case.

Given a centered input beam, it is specified for illustration purposes that the position of the vertex point and the maximum of the energy distribution correspond to one another. (This would actually conform to the case where the line focus and the energy distribution are considered in a vacuum.) Of course, this is not the case when the line focus is formed in the substrate material, rather there can be a deviation between the location of the vertex point and the location of the maximum. With an increasing offset (identified by dx in the left-hand part of FIG. 6) of the input being (identified by a circle) within the here horizontal plane of symmetry (mirror plane) of the phase distribution, the location of the maximum of the energy distribution is shifted relative to the vertex point of the Airy trajectory.

The right-and part of FIG. 6 shows how, as the offset changes from −0.5 mm to 0.5 mm, the energy distribution 15 along the Airy line focused trajectory 17 is shifted from the top toward the bottom in FIG. 6.

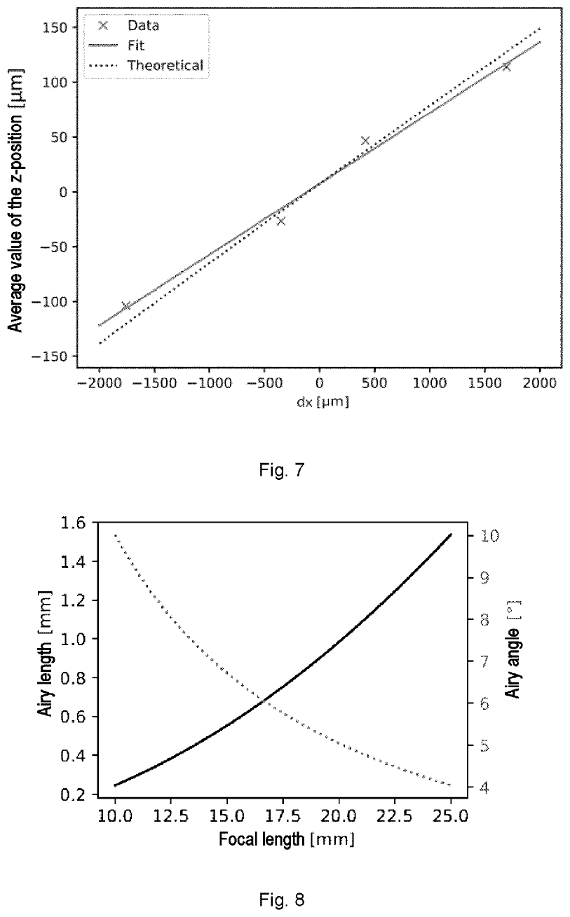

FIG. 7 shows the profile of the dependence between the offset dx of a laser beam on the cubic phase mask from the saddle point thereof and the position of the maximum of the line energy density along the focus trajectory.

In this case, the average value of the z-positions (i.e., The depth positions) of the associated material modification end points (which were identified by circular areas in FIG. 3, for instance) was used as an experimental position.

The gradient of the fit (“Fit”; solid line in FIG. 7) to the experimental data (“Data”) is 0.065. That is to say that for the focusing on which the data are based, the focus offset in the z-direction (in air) of 65 μm is attained per shift of the beam on the cubic phase mask by one millimeter.

FIG. 7 additionally illustrates the theoretically expected profile in a dotted manner. The theoretical profile for an offset of dx results as a change df in focal length at the cubic phase mask according to the equation, indicated here once again:

$$df = \frac{1}{\frac{1}{{f}_{0}} + \frac{\sqrt{2} {β}^{3} dx}{{k}_{0}}} - {f}_{0}$$

In this case:
k₀ is the wave vector where k₀=2*pi*n/lambda, with wavelength lambda, here 1030 nm, and refractive index n of the medium within which the focus is formed, here n=1
f₀ is the focal length of the focusing optical unit, here 10 mm
beta is the scaling factor of the cubic phase phi, where

$$φ = exp ( \frac{i β}{3} * ( {x}^{3} + {y}^{3} ) )$$

here where β=3^{1/3} mm⁻¹ for x and y in mm.

The explanations show, and thus once again with reference to FIG. 1: By virtue of the laser beam 3 being influenced by the phase mask 5 by virtue of the latter being shifted relative to the laser beam 3, for example, and by virtue of the pulse energy of the laser beam 3 being adjusted, the energy distribution introduced into the substrate by the line focus can thus be reliably controlled. It is thus possible to form modifications in the substrate 9 reliably and symmetrically.

Primarily by the mutually coordinated selection of pulse energy and influencing of the laser beam by the phase mask (for instance by the selection of the offset of the laser beam from the saddle point of the phase mask), the position of the maximum of the energy distribution within the substrate (identified by Δz₁ in the enlarged partial illustration in FIG. 1) can be reliably controlled.

### Influence of the Focal Length of the Focusing Optical Unit

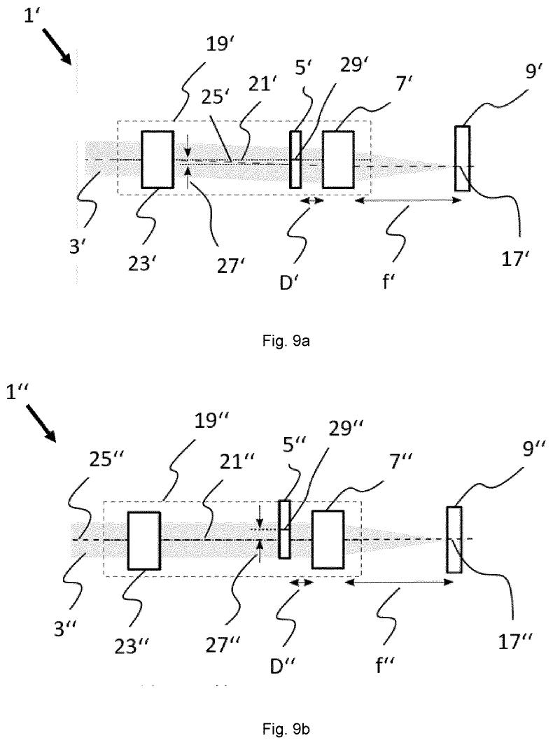

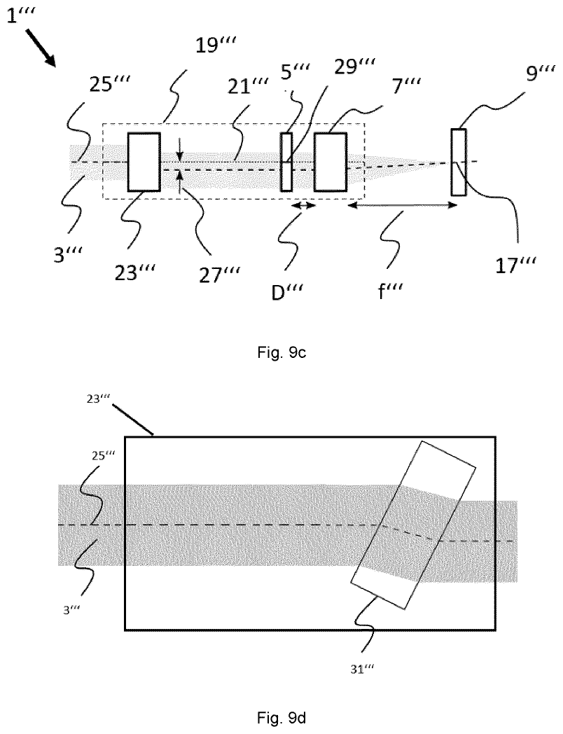

FIG. 8 illustrates the influence of the focal length of the focusing optical unit for an Airy laser beam; For constant:
cubic phase (where beta=3^{1/3}10³/m);
laser wavelength (where lambda=1.030×10⁻⁶ m); and
beam diameter (diameter of the raw beam w₀=5×10⁻³ m),
   there is an increase in the length of the focus region (in a relative definition: fall to 1/e² of the maximum value) as the focal length increases (curve with solid line in FIG. 9), and a decrease in the angle formed between the focus at the upper and lower ends and in each case the optical axis (curve with dashed line in FIG. 9). The left ordinate thus relates to the solid line and the right ordinate relates to the dashed line.

### Examples for Producing a Beam Offset

FIGS. 9a-c show different possibilities for producing an offset of the laser beam on a phase mask. It can be assumed here that the saddle point of the phase function on the respective phase mask, and thus the central point, is each situated at the geometric center point of the respective phase mask.

FIG. 9a shows an optical set-up 1′ similar to the optical set-up 1 shown in FIG. 1. Therefore, identical features are also provided with reference signs that are identical but with an additional single prime symbol.

In FIG. 9a, the optical system is identified by 19′, and its optical axis by 21′. Besides the phase mask 5′ and the focusing optical unit T, the optical system 19′ also comprises a deflection optical unit 23′.

This deflection optical unit 23′ deflects the laser beam 3′ so that the latter passes obliquely with respect to the optical axis 21′. This is readily evident from the center axis 25′ of the beam 3′, which axis runs obliquely (and the longer parallel to the optical axis 21′) downstream of the deflection optical unit 23′.

On account of the deflection, the laser beam 3′ is incident with an offset 27′ on the phase mask 5′. The incidence point of the laser beam 3′ (put better the location of the centroid of the beam cross-section in the plane of the phase mask 5′) on the phase mask 5′ therefore has the lateral offset 27′ in relation to the center point 29′ of the phase mask 5′.

FIG. 9b shows an optical set-up 1″ similar to the optical set-up 1′ shown in FIG. 9a. Therefore, identical features are also provided with reference signs that are identical but with an additional double prime symbol.

However, the optical system 19″ does not comprise a deflection optical unit 23″ or the latter (as in FIG. 9b) has no effect, and so the beam 3″ is not deflected. However, the phase mask 5″ is shifted perpendicularly to the beam direction, and so as a result the laser beam 3″ is incident with an offset 27″ on the phase mask 5″.

FIG. 9c shows an optical set-up 1′″ similar to the optical set-up 1′ shown in FIG. 9a and to the optical set-up 1″ shown in FIG. 9b. Therefore, identical features are also provided with reference signs that are identical but with an additional triple prime symbol.

The optical system 19′″ comprises a deflection optical unit 23c″, which produces an offset 27′″ of the laser beam 3′″, as is readily discernible from a comparison of the course of the center axis 25′″ of the laser beam 3′″ upstream and downstream of the deflection optical unit 23′″.

As a result, the laser beam 3′″ is incident with an offset 27′″ on the phase mask 5′″. In this case, however, the center point 29′″ of the phase mask 5′″ (as in the optical set-up 1′ in FIG. 9a) is on the optical axis 21′″.

FIG. 9d illustrates a form of realization of the deflection optical unit 23′″. The deflection optical unit 23′″ can comprise a rotated plate 31′″. The latter produces the offset 27′″.

### Phase Functions

Various exemplary phase functions which can be imposed on a laser beam, and which can be used as a phase mask for the method according to the disclosure are presented in the following table:

| Acceleration profile | Phase |
|---|---|
| Parabolic: c(z) = az² | ϕ(y) = −4/3 a^{1/2} k y^{3/2} |
| Quaternary: c(z) = az⁴ | ϕ(y) = −16/21 (3a)^{1/4} k y^{7/4} |
| Logarithmic: c(z) = a ln(bz) | ϕ(y) = e⁻¹a²b k (1 − exp[−y/a]) |
| Polynomial: c(z) = az^{a} (for even n) | $ϕ ( y ) = {kn}^{2} {y}^{2} \frac{{[ a ( 1 - n ) / y ]}^{1 / n}}{( 2 n - 1 ) ( 1 - n )}$ |

The parameters are described in the publication Froehly, L., Courvoisier, F., Mathis, A., Jacquot, M., Furfaro, L., Giust, R., & Dudley, J. M. (2011). Arbitrary accelerating micron-scale caustic beams in two and three dimensions. Optics express, 19(17), 16455-16465.

Preferably, the optical set-up for producing the phase functions mentioned above is an optical set-up comprising a telescopic set-up for focusing the laser beam.

### Further Embodiments

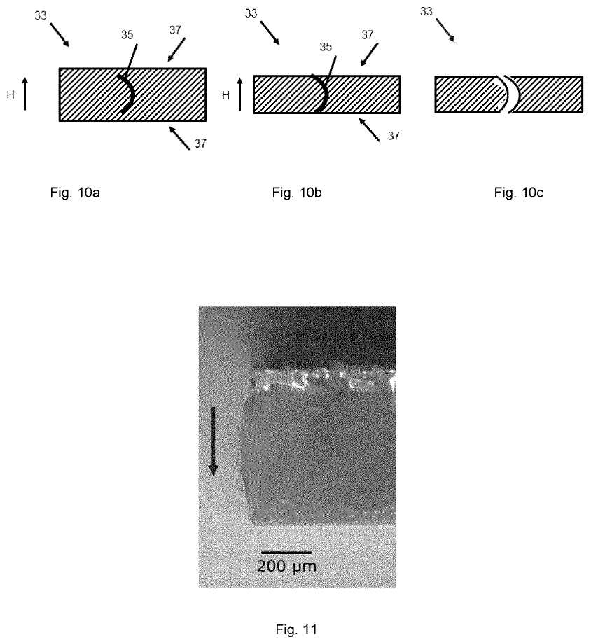

FIG. 10 a shows a rectangular substrate 33 in a cross-sectional view. Within the substrate 33, the substrate material was modified in a region 35 on account of the energy deposited in the substrate 33 by the line focus, in particular as a result of an interaction between the energy and the substrate material.

The curved region 35 is completely enclosed within the substrate 33.

Therefore, according to the disclosure, embodiments provide for material to be removed from the substrate 33 by etching, for example. This can take place along the main extension direction H of the curved region 35 (or of the line focus having a corresponding course), said direction running perpendicularly to both outer surfaces 37 in the present case. In other words, in this respect, material is thus removed from the two outer surfaces 37 of the substrate 33. As a result, the new outer surfaces 37 of the substrate 33 are shifted as it were along the main extension direction H. This can be discerned in FIG. 10b. The latter additionally reveals that the substrate material 35 influenced in the enclosed curved region 35 becomes accessible externally as a result of the removal of substrate material since parts of the influenced substrate material are now situated at the surface of the outer surfaces 37.

The curved region 35 has a course that is not influenced by surface effects (for instance of the outer surfaces 37), since the interaction takes place completely within the substrate 33 (FIG. 10a).

By virtue of the accessibility of the modified substrate material 35 (FIG. 10b), the substrate can subsequently be processed further, as is illustrated in FIG. 10c. By way of example, for this purpose, the influenced material is removed by etching and the substrate is divided.

### Further Aspects

FIG. 11 shows a plan view of a substrate processed by the method according to the disclosure. In particular, the normal vector of the surface formed (that is to say of the curved separating surface) runs in the plane of the drawing in FIG. 16. Therefore, the curved course of the separating service can also be discerned particularly advantageously in FIG. 11.

The symmetrical course of the curved separating surface can primarily be discerned.

In this case, the laser beam used passed parallel to the plane of the drawing in FIG. 11, as indicated by the arrow.

The following general parameters and laser parameters were set for the laser processing:
substrate material having a thickness selected from the range of between 900-1000 μm, for example B F 33;
a pitch of 40 μm;
microscope objective and/or Fourier lens having a focal length of f=10 mm;
x2.0 beam expander (with the Gaussian input beam having a diameter of 10 mm);
pulse duration [symbol] =5 ps;
number of pulses in the burst of N=2;
energy per burst of 300 μJ; and
wavelength of 1030 nm;
cubic phase φ=exp(i*(x³+y³)), equivalent to

$$φ = exp ( \frac{i β}{3} * ( {x}^{3} + {y}^{3} ) )$$

where β=3^{1/3} mm⁻¹ for x and y in mm;

By virtue of the fact that, as here, a sufficiently large pitch is chosen, interactions between adjacent regions in the substrate with modifications are avoided or at any rate greatly reduced.

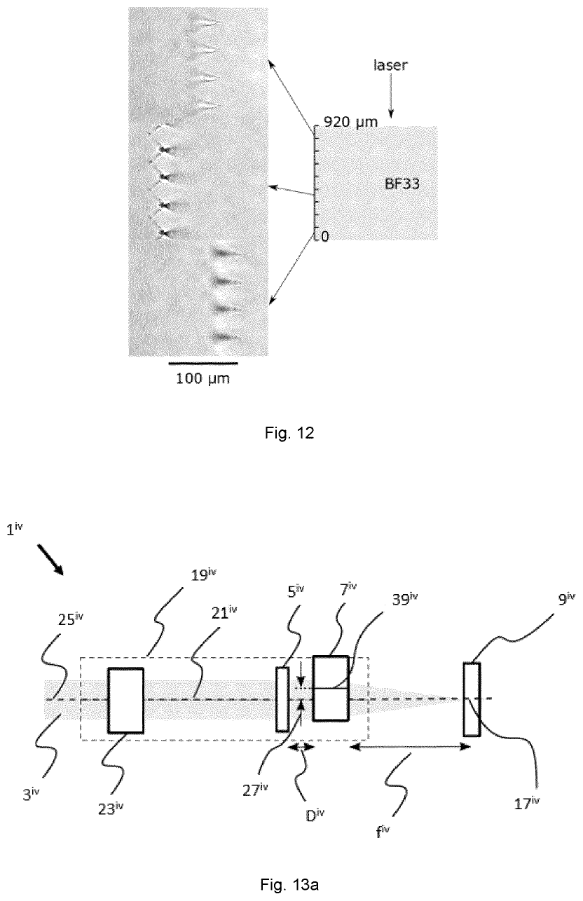

FIG. 12 shows on the left plan views of the substrate using transmitted-light microscopy, specifically after the laser process but before etching (the view here is parallel to the laser propagation direction). The lateral manifestation of the modifications can be seen here, where a plurality of modifications can be seen in each case for three selected, different depths in the substrate. The respective depths are marked in the right-hand part of FIG. 12.

A sufficiently large pitch was chosen when introducing the modification, with the result that the outliers of the modifications manifested in laterally angular/arrowlike fashion overlap only minimally. This ensured that the propagation in the material is not disturbed, or is only slightly disturbed, by preceding modifications.

The “zigzag” pattern thus results from the modifications extended laterally in proximity to the focus, while the modifications still lie on a straight line/line. Moreover, the vertex of the curved line focus was advantageously kept centrally between the two outer surfaces and the line focus was formed completely within the substrate material.

### Supplementary Aspects

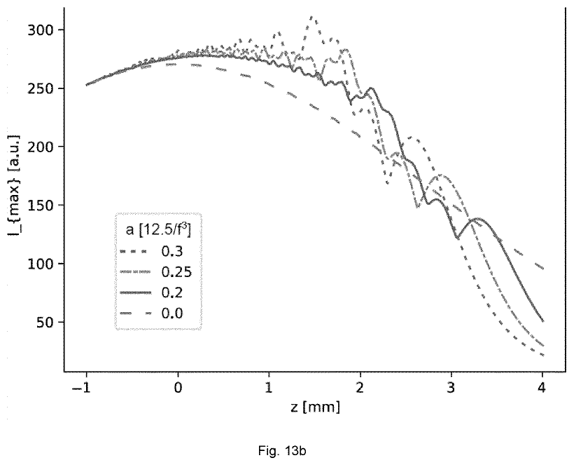

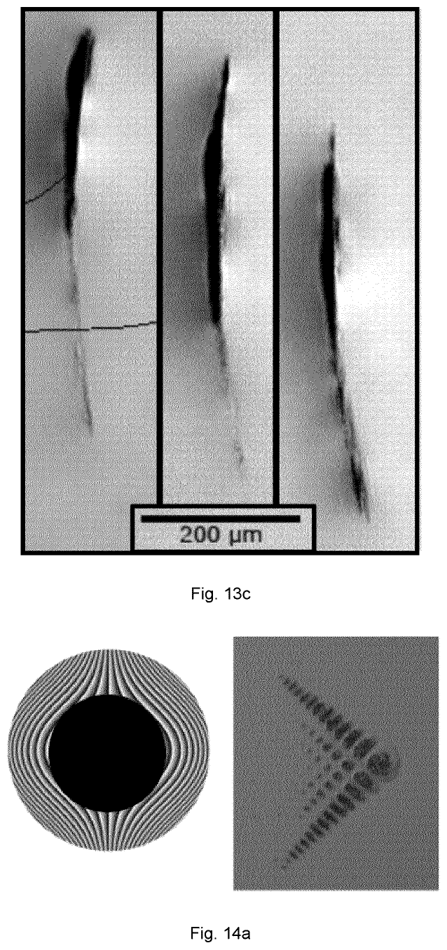

FIG. 13a shows an optical set-up 1^{iv} which can control the spherical aberration and advantageously likewise the tilt of the modification in the substrate. The optical set-up 1^{iv} is similar to the optical set-ups 1′, 1″ and 1′″ shown in FIGS. 9a to 9c. Therefore, identical features are also provided with reference signs that are identical but with an additional quadruple prime symbol.

In the present case, the focusing optical unit 7^{iv} is an imaging optical unit having a spherical aberration. If the laser beam passes through this focusing optical unit 7^{iv}, it acquires a spherical aberration, specifically preferably depending on its incidence point on the focusing optical unit 7^{iv}.

The focusing optical unit 7^{iv} could comprise a lens having spherical aberration whose phase satisfies the following equation:

$${ϕ}_{lens} ( ρ ) = k 0 * ( \frac{{ρ}^{2}}{2 f} + a {ρ}^{4} )$$

The deflection optical unit 23^{iv} is deactivated in the present case, and so the beam 3^{iv}is not deflected. If it is activated, the incidence point of the laser beam 3^{iv} on the focusing optical unit 7^{iv} could (also) be adapted by the deflection optical unit 23^{iv} and the spherical aberration of the laser beam 3^{iv} and/or the tilt of the modification introduced into the substrate could also be changed.

However, in the present case, the deflection optical unit 23^{iv} is deactivated and thus has no effect, and so the beam 3^{iv} is not deflected. However, the focusing optical unit 7^{iv} is shifted perpendicularly to the beam direction, and so as a result the laser beam 3^{iv} is incident on the focusing optical unit 7^{iv} with an offset 27^{iv} with respect to the center point 39^{iv} of the focusing optical unit 7^{iv}.

As a result of the offset 27^{iv}, the laser beam acquires an adapted spherical aberration, and so the energy distribution introduced within the substrate 9^{iv} is changeable and/or displaceable along the line focus 17^{iv}.

FIG. 13b the shows intensity profiles of a laser beam along a depth direction of a substrate for differently adjusted spherical aberrations. For this purpose, for example, in the context of the optical set-up 1^{iv}, the offset 27^{iv} can be changed each case so that the line focus formed in the substrate 9^{iv} has a different energy distribution.

With increasing spherical aberration, a back portion of the line focus (i.e., A portion toward greater depths z in the substrate) can be amplified in terms of intensity. As a result, a modification can be formed better along the entire depth region and always reduced laser power in the substrate material.

FIG. 13c shows three substrates (illustrated on the left, in the middle and on the right in the Fig.) with modifications introduced in conjunction with differently adjusted spherical aberrations and offsets of the input beam.

The spherical aberration was adjusted here in each case by way of a different offset (cf. The offset 7 explained with reference to FIG. 13a) of the laser beam and of the focusing optical unit of the optical system used for this purpose.

For the modification of the substrate illustrated on the left in FIG. 13c, an offset of 0 mm was set, hence no offset. For the modification of the substrate illustrated in the middle in FIG. 13c, an offset of 0.7 mm was set. For the modification of the substrate illustrated on the right in FIG. 13c, an offset of 1.4 mm was set.

The three substrates illustrated in FIG. 13c are all illustrated with identical thickness and in a manner oriented in alignment with their top side. Therefore, it can be gathered from FIG. 13c that as the offset increases, the modification becomes longer and takes place to a more pronounced degree even at greater depths (in FIG. 13c, this modification proceeds in each case along the vertical axis with downwardly increasing depth). The reason for this is that the energy distribution, too, along the line focus trajectory is longer and more pronounced toward the back in the manner in which it is introduced into the substrate material, and it is controlled there if the spherical aberration increases as illustrated.

### Further Advantageous Features Concerning Dynamic Influencing

With regard to dynamic influencing, it has been recognized as particular advantageous that the phase mask and/or a DOE, in particular an incidence point of the laser beam on the phase mask, a focus led, in particular a focus length of a microscope objective of the optical set-up, a spherical aberration of the laser beam, in particular an incidence point of the laser beam on a lens, and/or the pulse energy of the laser beam, can be selected as parameters of the dynamic influencing and can be time-dependently changed individually and in any desired combination for the dynamic influencing.

### Exemplary Process Parameters and Modification Produced Therewith

Several experiments 1-5 were carried out; in these experiments, modifications were introduced into a glass substrate by a laser. The associated process parameters, i.e., in particular the settings for various laser parameters, information concerning the optical set-up (for example offset of the beam on the phase mask or focus length of the microscope) and also the number of bursts (“Number of shots”), are indicated in the table below. The optical set-up used in the experiments can be similar for example to the optical set-up described with reference to FIG. 13a.

The experiments 1-5 constitute examples of dynamic influencing since the respective modification was introduced into the substrate in each case by a line focus that was changed time-dependently (owing to a time-dependently changed offset of the laser beam on the phase mask).

The last four rows of the table contain indications concerning the modifications introduced in the respective substrate in the respective experiments 1-5. In this case, the “Length of the modification in the substrate” is measured along the substrate thickness. Moreover, the indication concerning the “Offset of the modification along the thickness direction of the substrate” indicates the vertical distance between the location of maximum material damage and the center of the substrate. The information concerning the “Overlap of the modifications” indicates to what extent the adjacent modifications produced by shifting the energy distribution along the trajectory overlap, where here the value is multiplied by 100 indicate the overlap in % (where a negative value would indicate a distance between two modifications). (Therefore, even though here a discrete process is preferably present in order to introduce adjacent instances of damage into the substrate material along the trajectory, in other advantageous embodiments it would also be conceivable for the modification to be propagated continuously in the substrate material.) The “Maximum substrate thickness” indicates the substrate thickness which is maximally processable with the process parameters.

The processable substrate thickness advantageously results from the modification length of all individual shots, where the length of an individual modification (here: “Length of the modification in the substrate”) and the overlap of the modifications are taken into account.

In the table, as an exemplary embodiment for the dynamic case, each column relates to a multiplicity of shots at different depths, but at a lateral position. By contrast, FIG. 13c shows the individual modifications which correspond to the static case. The values in column 1 of the table result from comparison of the modifications in the middle and on the right into 13c.

| Parameter | 1 | 2 | 3 | 4 | 5 |
|---|---|---|---|---|---|
| Laser wavelength [nm] | 1030 | 1030 | 1030 | 1030 | 1030 |
| Pulse duration [ps] | 5 | 5 | 5 | 5 | 5 |
| Number of pulses in the burst | 4 | 4 | 4 | 4 | 4 |
| Beam diameter [mm] | 5.3 | 2.65 | 1.1 | 1.1 | 1.1 |
| Laser parameter beta [1/mm] | 1.44 | 1.44 | 2.47 | 1.44 | 1.82 |
| Focus length of microscope | 10 | 10 | 10 | 22.4 | 31.6 |
| objective [mm] | | | | | |
| Beam offset on phase | 713 | 2500 | 1000 | 1000 | 500 |
| mask [μm] | | | | | |
| Number of shots | 2 | 8 | 20 | 20 | 10 |
| Energy per burst [μJ] | 144 | 72 | 30 | 67 | 95 |
| Length of the modification in | 510 | 255 | 529 | 529 | 2117 |
| the substrate [μm] | | | | | |
| Offset of the modification along | 72 | 254 | 508 | 508 | 1015 |
| the thickness direction of the | | | | | |
| substrate [μm] | | | | | |
| Overlap of the modifications | 0.86 | 0.00 | 0.04 | 0.04 | 0.52 |
| Max. substrate thickness [mm] | 0.58 | 2 | 10 | 10 | 11 |

### Influence of the Beam Cross-Section

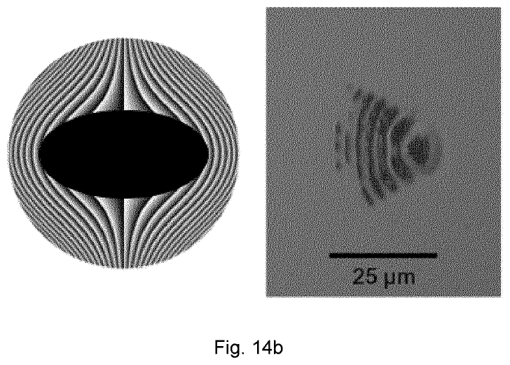

FIG. 14a shows on the left a cubic phase mask with a depicted circular area, which is intended to represent the cross-section of a laser beam incident on the phase mask. By a laser beam having such a cross-section in the plane of the phase mask, a material modification was introduced in a glass substrate.

A plan view of the corresponding substrate is illustrated on the right in FIG. 14a. That outer surface of the substrate which faces the phase mask is thus shown. The material modification produced by the primary maximum of the line focus can be seen here on the far right. The material modifications produced by the secondary maxima of the line focus form arrowlike/angular outliers.

FIG. 14b shows on the left again a cubic phase mask with a depicted oval area, which is intended to represent the cross-section of a different laser beam incident on the phase mask. By a laser beam having such an oval cross-section in the plane of the phase mask, a material modification was introduced in a further glass substrate.

A plan view of the corresponding substrate is illustrated on the right in FIG. 14b. That outer surface of the substrate which faces the phase mask is thus shown. The material modification produced by the primary maximum of the line focus can again be seen here on the far right. As a result of the elongated beam cross-section, the material modifications caused by the secondary maxima become more compact and blur to form circle-segment-like structures in the outer surface. In the substrate itself, these modification structures are arranged in a manner resembling an onion skin with respect to one another. Moreover, a clearer contrast between primary and secondary maxima all the modifications respectively caused by them is discernible.

Owing to the more compact damage region in the substrate, adjacent modifications disturb one another to a lesser degree. Moreover, more favorable cracking along a plurality of adjacent modifications was observed during the formation of a separating surface. This was the case even with a comparatively large pitch of, for example, 1 μm or more or even 10 μm or more. This can possibly be attributable to the fact that the secondary maxima can run parallel to the cut edge.

### LIST OF REFERENCE SIGNS

1, 1′, 1″, 1′″, 1^{iv} Optical set-up
3, 3′, 3″, 3′″, 3^{iv} Laser beam
5, 5′, 5″, 5′″, 5^{iv} Phase mask
7, 7′, 7″, 7′″, 7^{iv} Focusing optical unit
9, 9′, 9″, 9′″, 9^{iv} Substrate
11 Substrate
13 Substrate region
15 Energy distribution
17, 17′, 17″, 17′″, 17^{iv} Line focus trajectory
19′, 19″, 19′″, 19^{iv} Optical system
21′, 21″, 21′″, 21^{iv} Optical axis
23′, 23″, 23′″, 23^{iv} Deflection optical unit
25′, 25″, 25′″, 25^{iv} center axis of the laser beam
27′, 27″, 27′″, 27^{iv} Offset
29′, 29″, 29′″ Center point of the phase mask
31′″ Plate
33 Substrate
35 region
37 Outer surface
39^{iv} center point of the focusing optical unit
d Distance
5 D, D′, D″, D′″D^{iv} Distance
f, f′, f″, f′″, f^{iv} Focus length
H Main extension direction
R direction
ω₀ Beam diameter
Δz, Δz₁, Δz₂ Depth region

What is claimed is:

1. A method for controlling an energy distribution introduced by at least one line focus of at least one laser beam within a substrate, the method comprising:
forming the line focus at least regionally within the substrate; and
influencing the laser beam with at least one phase mask to control the energy distribution within the substrate.

2. The method as claimed in claim 1,
wherein the at least one phase mask is a phase mask with a cubic phase distribution or a higher-order distribution; and/or
wherein the phase mask is arranged in a beam path of the laser beam upstream of the substrate, and the laser beam has an incidence point on the phase mask.

3. The method as claimed in claim 1,
wherein the forming the line focus comprises adjusting a position of a vertex point of the line focus along a depth region of the substrate, and
wherein the position of the vertex point of the line focus:
(i) is adjusted centrally along the depth region of the substrate, and/or
(ii) a vertical distance from the central position along the depth region of the substrate is
(a) more than 0.1% of a thickness of the substrate, and/or
(b) less than 50% of the thickness of the substrate, and/or
(c) between 0.1% and 49% of the thickness of the substrate.

4. The method as claimed in claim 1,
wherein the influencing the laser beam comprises adjusting a pulse energy, a pulse duration, a number of pulses in a burst, an energy distribution in the burst and/or a wavelength of the laser,
wherein the pulse energy is adjusted so that the line focus in the substrate has at least one portion along which the substrate is modified by energy deposited in the substrate,
wherein the at least one portion has a length of
(a) more than 0.1 mm and/or between 0.1 mm and 5 mm, and/or less than 5 mm, and/or
(b) more than 0.3 mm and/or less than 5 mm, and/or
(c) more than 0.5 mm and/or between 0.5 mm and 2 mm and/or less than 5 mm and/or,
10 (d) more than 0.7 mm and/or less than 5 mm and/or,
(e) more than 3 mm and/or less than 5 mm, and/or
(f) more than 5 mm, and/or
(g) less than 0.1 mm.

5. The method as claimed in claim 4, wherein
(i) the pulse energy is adjusted
(a) to 50 μJ or more and/or 5000 μJ μJ or less, and/or
(b) to 100 μJ or more and/or to 5000 μJ or less, and/or
(c) to 200 μJ or more and/or to 5000 μJ or less, and/or
(d) to 300 μJ or more and/or to 5000 μJ or less, and/or
(e) to 400 μJ or more and/or to 5000 μJ or less, and/or
(f) to 500 μJ or more and/or to 5000 μJ or less, and/or
(g) to 600 μJ or more and/or to 5000 μJ or less, and/or
(h) to 1000 μJ or more and/or to 5000 μJ or less, and/or
(i) to 1500 μJ or more and/or to 5000 μJ or less, and/or
(j) to 2000 μJ or more and/or to 5000 μJ or less, and/or
(k) to 2500 μJ or more and/or to 5000 μJ or less, and/or
(l) to 3000 μJ or more and/or to 5000 μJ or less, and/or
(m) to 3500 μJ or more and/or to 5000 μJ or less, and/or
(n) to 4000 μJ or more and/or to 5000 μJ or less, and/or
(o) to 4500 μJ or more and/or to 5000 μJ or less, and/or
(p) to 5000 μJ or more, and/or
(q) to 50 μJ or less, and/or
(ii) the pulse energy is adjusted so that there is an average line energy density of
(a) 1 μJ/mm or more and/or 200 μJ/mm or less, and/or
(b) 5 μJ/mm or more and/or 1000 μJ/mm or less, and/or
(c) 10 μJ/mm or more and/or 1000 μJ/mm or less, and/or
(d) 20 μJ/mm or more and/or 1000 μJ/mm or less, and/or
(e) 30 μJ/mm or more and/or 1000 μJ/mm or less, and/or
(f) 40 μJ/mm or more and/or 1000 μJ/mm or less, and/or
(g) 50 μJ/mm or more and/or 1000 μJ/mm or less, and/or
(h) 60 μJ/mm or more and/or 1000 μJ/mm or less, and/or
(i) 70 μJ/mm or more and/or 1000 μJ/mm or less, and/or
(j) 80 μJ/mm or more and/or 1000 μJ/mm or less, and/or
(k) 90 μJ/mm or more and/or 1000 μJ/mm or less, and/or
(l) 100 μJ/mm or more and/or 1000 μJ/mm or less, and/or
(m) 150 μJ/mm or more and/or 1000 μJ/mm or less, and/or
(n) 200 μJ/mm or more and/or 1000 μJ/mm or less, and/or
(o) 250 μJ/mm or more and/or 1000 μJ/mm or less, and/or
(p) 300 μJ/mm or more and/or 1000 μJ/mm or less, and/or
(q) 350 μJ/mm or more and/or 1000 μJ/mm or less, and/or
(r) 400 μJ/mm or more and/or 1000 μJ/mm or less, and/or
(s) 500 μJ/mm or more and/or 1000 μJ/mm or less, and/or
(t) 600 μJ/mm or more and/or 1000 μJ/mm or less, and/or
(u) 700 μJ/mm or more and/or 1000 μJ/mm or less, and/or
(v) 800 μJ/mm or more and/or 1000 μJ/mm or less, and/or
(w) 900 μJ/mm or more.

6. The method as claimed in claim 4,
wherein the influencing the laser beam comprises:
(a) adjusting a spatial extent of the energy distribution, and/or
(b) shifting a position of the maximum material damage caused by a nonlinear interaction between the laser and substrate material, and/or
(c) shifting the position of a maximum of the energy distribution and/or a centroid of the energy distribution along a trajectory the line focus,
wherein
(i) after adapting a position of the energy distribution, at least one maximum of the energy distribution is positioned at a vertex point of the line focus, and/or
(ii) after adapting the spatial extent and/or the position of the energy distribution, a modification of the substrate material that proceeds along an entire substrate thickness is carried out or takes place, and/or
(iii) adapting the position of the energy distribution at least partly comprises coordinating the influencing of the laser beam by the phase mask and the adjusting of the pulse energy with one another.

7. The method as claimed in claim 1,
wherein the influencing the laser beam comprises offsetting the laser beam to be incident with respect to a central point of the phase mask,
wherein the central point is a location of the phase mask at which a laser beam incident on the phase mask with a diameter tending toward zero is influenced by a saddle point of a phase distribution imposed on the phase mask, and
wherein the offsetting is between 0.1 μm and 5000 μm.

8. The method as claimed in claim 7,
wherein
(i) the offsetting is adjusted by
(a) moving the phase mask relative to the laser beam; and/or
(b )rotating at least one plane-parallel plate composed of a glass material and/or an optical material transparent at a wavelength of the laser beam; and/or
(c) arranging at least two prisms in a beam path of the laser beam; and/or
(d) translating a deflection mirror that deflects the laser beam;
and/or
(ii) wherein the offsetting is adjusted by deflecting the laser beam so that a direction vector of the beam incident on the phase mask forms an angle with the direction vector of the center axis of the phase mask, wherein the angle is 1/500 radian or less.

9. The method as claimed in claim 1,
wherein the influencing the laser beam is carried out time-dependently and the energy distribution is changed time-dependently.

10. The method as claimed in claim 9,
wherein the laser beam is influenced by different regions of the phase mask at different time periods, and a centroid of a beam cross-section existing in a plane of the phase mask has different incidence points on the phase mask during the different time periods.

11. The method as claimed in claim 9,
wherein at least one maximum of the energy distribution is moved in the substrate from a larger to a smaller depth and/or along a focus trajectory within the substrate.

12. The method as claimed in claim 1,
wherein influencing the laser beam comprises changing an intensity distribution of the laser beam on the phase mask at a location of an incidence of the beam on the phase mask by shifting the intensity distribution spatially on the phase mask.

13. The method as claimed in claim 1, wherein by an energy distribution introduced by the line focus,
(a) a material property of the substrate is modified at least regionally,
wherein the material property is density, refractive index, stress value and/or etching rate, and/or
(b) microcracks are produced at least regionally in the substrate material, and/or
(c) material is removed from the substrate and/or displaced at least regionally.

14. The method as claimed claim 1, further comprising:
forming two or more line foci of two or more laser beams within the same region in the substrate, in parallel and/or sequentially over time;
controlling an energy distribution introduced into the substrate by the two or more line foci,
wherein
(a) the energy distributions introduced by individual line foci of the two or more line foci are different with regard to position and/or shape,
and/or
(b) trajectories of the two or more line foci are congruent.

15. The method as claimed in claim 1,
wherein an orientation of at least one portion of the line focus in the substrate relative to the main propagation direction of the laser beam in the substrate is adjusted by controlling the energy distribution in the substrate and by adapting the focus position in the substrate,
wherein the adapting the focus position takes place by changing a distance between a focusing optical unit and the substrate and/or a thickness of the substrate is less than half a length of the line focus potentially possible for a given optical set-up along a thickness extension of the substrate.

16. The method as claimed in claim 1, wherein
(i) the line focus is a focus of an Airy beam, and/or
(ii) the line focus has a maximum deflection from a straight course of more than 20 μm, and/or
(iii) the laser beam is emitted by a pulsed laser, and/or
(iv) the wavelength of the laser beam is selected from a wavelength range of between 200 nm and 1500 nm, the microscope objective or the Fourier lens of a focusing optical unit by which the laser beam is focused onto the substrate has a focal length of 10-20 mm, the coefficient of the cubic phase (laser parameter beta) has a value of between 0.5×10³/m and 5×10³/m, the diameter of the raw beam (laser parameter c.30) has a value of between 1 mm and 10 mm, the pulse duration (laser parameter C) has a value of 0.1-10 ps, the pulse energy (laser parameter Eₚ) has a value of between 1 and 1500 μJ, and/or the number of pulses in the burst (laser parameter N) has a value of between 1 and 200, and/or
(v) the pulse energy of the laser is sufficient to modify at least one material property of the substrate or to remove or to displace material from the substrate along a specific portion of the line focus, wherein the specific portion is shorter than an extent of the substrate region where the at least one material property is intended to be modified or that is intended to be removed or displaced.

17. The method as claimed in claim 13,
wherein regions of the substrate in which the material property is modified are opened by producing a mechanical and/or thermal stress and/or by an etching method to produce a through hole and/or a blind hole within the substrate material,
and/or
wherein the regions are opened along a closed contour and/or along a modification proceeding from one substrate side to another substrate side by a mechanical, thermal and/or chemical processes to produce an inner or outer contour with a shaped side surface.

18. The method as claimed in claim 1, further comprising:
arranging at least one auxiliary substrate at the substrate,
wherein the line focus extends at least partly into the auxiliary substrate.

19. The method as claimed in claim 1, wherein the line focus is enclosed completely within the substrate, and the method further comprises:
at least regionally removing material from the substrate along the main extension direction of the line focus within the substrate thereby rendering a modified material enclosed in the substrate accessible at least partly and/or regionally from outside the substrate.

20. The method as claimed in claim 1, wherein the influencing the laser beam further comprises:
(i) providing a spherical aberration to the laser beam at least in the region of the line focus, and/or
(ii) adjusting a spherical aberration of the laser beam at least in the region of the line focus.

21. The method as claimed in claim 20, wherein the laser beam propagates through an optical element with spherical aberration so that the spherical aberration of the laser beam is at least partly adjusted at least in the region of the line focus.

22. The method as claimed in claim 20, wherein the spherical aberration is a fourth-order spherical aberration has a strength of 0.02/(f*w0 \hat{ }2) or more, wherein f is a focal length of an imaging system and w0 is a diameter of the laser beam.

23. The method as claimed in claim 20,
wherein the spherical aberration results in a lengthening of the focus formed within the substrate
(a) by 5% or more and/or by 100% or less, and/or
(b) by 10% or more and/or by 100% or less, and/or
(c) by 15% or more and/or by 100% or less, and/or
(d) by 20% or more and/or by 100% or less, and/or
(e) by 25% or more and/or by 100% or less, and/or
(f) by 30% or more and/or by 100% or less, and/or
(g) by 35% or more and/or by 100% or less, and/or
(h) by 40% or more and/or by 100% or less, and/or
(i) by 50% or more and/or by 100% or less, and/or
(j) by 60% or more and/or by 100% or less,
and
wherein the focus length exists along a portion of a laser beam trajectory at which the line focus has an intensity that is 75% or more of the maximum intensity of the line focus.

24. The method as claimed in claim 20, wherein the spherical aberration of the laser beam is varied over time in the region of the line focus by a temporal variation of an incidence point of the laser beam on the phase mask and/or an optical element .

25. The method as claimed in claim 24, wherein the center point of a laser beam incident on the optical element is incident on the optical element at least at times with an offset with respect to an optical axis of the optical element.

26. The method as claimed in claim 25, further comprising:
adjusting a constant and/or maximum offset that is
(a) 20 mm or less and/or of 0.001 mm or more, and/or
(b) 15 mm or less and/or of 0.001 mm or more, and/or
(c) 10 mm or less and/or of 0.001 mm or more, and/or
(d) 5 mm or less and/or of 0.001 mm or more, and/or
(e) 3 mm or less and/or of 0.001 mm or more, and/or
(f) 2.5 mm or less and/or of 0.001 mm or more, and/or
(g) 2 mm or less and/or of 0.001 mm or more, and/or
(h) 1.5 mm or less and/or of 0.001 mm or more, and/or
(i) 1 mm or less and/or of 0.001 mm or more.

27. The method as claimed in claim 24, wherein the optical element is a lens white a spherical curvature.

28. The method as claimed in claim 20, wherein the spherical aberration is a fourth-order or higher-order spherical aberration.

29. The method as claimed in claim 20, wherein the spherical aberration is a spherical aberration according to Zernike polynomials with indices m=0 and n=2k for integral k>2.

30. The method as claimed in claim 24, wherein the spherical aberration and the influencing the laser beam are coordinated with one another by temporally varying an incidence point of the laser beam on the optical element and the incidence point of the laser beam on the phase mask.

31. The method as claimed in claim 20, wherein the energy distribution, an intensity and/or an intensity distribution of the back end portion of the line focus along the main extension direction of the line focus is adjustable by adjusting the spherical aberration.

32. The method as claimed in claim 20, wherein the energy distribution along the line focus along a trajectory of the line focus has a positioning that is changeable and/or adjustable by adjusting the spherical aberration.

33. The method as claimed in claim 1, further comprising:
changing a wavelength of the laser beam time-dependently; and
providing an optical element within a beam path of the laser beam upstream of the substrate,
wherein the optical element is configured to refract the laser beam wavelength-dependently.

34. The method as claimed in claim 1,
wherein the laser beam has an at least intermittently elongated beam cross-section at least in portions in a plane of the phase mask, and
wherein the beam cross-section is changed over time.

35. The method as claimed in claim 1, further comprising:
introducing a plurality of material modifications into the substrate that are adjacently spaced apart by a distance,
wherein the distance between each material modification of the plurality of material modifications is 1 μm or more.

36. The method as claimed in claim 1,
(i) wherein the substrate is transparent,
wherein the substrate is composed of glass and/or glass ceramic,
wherein the substrate has a first outer surface and/or a second outer surface,
wherein the second outer surface runs parallel to the first outer surface and/or is situated opposite the first outer surface,
and/or
(ii) wherein the substrate has a thickness measured between the first and second outer surfaces,
(a) of 10 μm or more, and/or
(b) of 10 mm or less, and/or
(c) of between 10 μm and 10 mm.

37. A substrate comprising:
at least one first outer surface;
at least one second outer surface running parallel to the first outer surface;
at least one laser-broken side surface which extends between the first and second outer surfaces; and
a contour of the side surface has a vertex point arranged between two outer surfaces of the substrate in a cross-sectional plane of the substrate that is spanned by a plane having at least one normal vector of the side surface and a normal vector of the first outer surface, and
wherein
(i) the vertex point
(a) is arranged centrally between the two outer surfaces,
and/or
(b) is arranged at a vertical distance from the central position between the two outer surfaces along a direction parallel to the normal vector of the first outer surface by
(1) more than 0.1% of a thickness of the substrate, and/or
(2) less than 50%, preferably less than 45% of the thickness of the substrate, and/or
(3) between 0.1% and 49%of the thickness of the substrate,
and/or
(ii) the side surface is height-modulated at least regionally along the main extension direction of the side surface and/or perpendicularly thereto,
and/or
(iii) the substrate has a curved modification with a course according to at least one portion of a trajectory of an Airy beam.

38. The substrate as claimed in claim 37,
wherein the thickness of the substrate is more than 500 μm.

39. The substrate as claimed in claim 37, wherein
(i) the substrate is transparent,
wherein the substrate is composed of glass and/or glass ceramic,
wherein the substrate has a first outer surface and/or a second outer surface, and
wherein the second outer surface runs parallel to the first outer surface and/or is situated opposite the first outer surface,
and/or
(ii) the substrate has a thickness measured between the first and second outer surfaces,
(a) of 10 μm or more, and/or
(b) of 10 mm or less, and/or
(c) of between 10 μm and 10 mm.
